(19) United States
(12) Patent Application Publication
(10) Pub. No.: US 2022/0404160 A1
(43) Pub. Date: Dec. 22, 2022

(54) ROUTE SELECTION USING INFRASTRUCTURE PERFORMANCE

(71) Applicant: 3M INNOVATIVE PROPERTIES COMPANY, St. Paul, MN (US)

(72) Inventors: Panagiotis D. Stanitsas, Palo Alto, CA (US); Andrew W. Long, Woodbury, MN (US); Payas Tikotekar, Woodbury, MN (US); Kenneth L. Smith, White Bear Lake, MN (US); Richard A. Fundakowski, St. Paul, MN (US); Onur Sinan Yordem, St. Paul, MN (US)

(21) Appl. No.: 17/763,822

(22) PCT Filed: Oct. 14, 2020
(86) PCT No.: PCT/IB2020/059658

§ 371 Date: Mar. 25, 2022

Related U.S. Application Data
(60) Provisional application No. 62/923,562, filed on Oct. 20, 2019.

(51) Int. Cl. G01C 21/34

(52) U.S. Cl. CPC G01C 21/3461

(57) ABSTRACT

Selecting navigation routes based on infrastructure performance values that indicate infrastructure performance of pathway articles. To select navigation routes, a computing device receives one or more infrastructure performance values. The infrastructure performance values can indicate infrastructure performance of the pathway article and may correspond to a roadway portion. The computing device may determine, based at least in part on the one or more infrastructure performance values, a navigation route comprising a set of roadway portions from an initial location to a subsequent location. The computing device may perform at least one operation based at least in part on the navigation route comprising the set of roadway portions from the initial location to the subsequent location.

### TECHNICAL FIELD The present application relates generally to pathway articles and systems in which such pathway articles may be used.

### BACKGROUND

Current and next generation vehicles may include those with a fully automated guidance systems, semi-automated guidance and fully manual vehicles. Semi-automated vehicles may include those with advanced driver assistance systems (ADAS) that may be designed to assist drivers avoid accidents. Automated and semi-automated vehicles may include adaptive features that may automate lighting, provide adaptive cruise control, automate braking, incorporate GPS/traffic warnings, connect to smartphones, alert driver to other cars or dangers, keep the driver in the correct lane, show what is in blind spots and other features. Infrastructure may increasingly become more intelligent by including systems to help vehicles move more safely and efficiently such as installing sensors, communication devices and other systems. Over the next several decades, vehicles of all types, manual, semi-automated and automated, may operate on the same roads and may need operate cooperatively and synchronously for safety and efficiency.

### SUMMARY

This disclosure is generally directed to selecting navigation routes based on infrastructure performance values that indicate infrastructure performance of pathway articles. In some instances, infrastructure performance of a pathway article may refer to the chromaticity or luminosity of light that is reflected from or corresponds to a pathway article. For example, infrastructure performance may be represented as a cap-Y value for a pavement marking or a retroreflected light value for a retroreflective sign. Rather than generating navigation routes between departure and destination location based on distance or congestion, techniques of this disclosure may generate navigation routes based on infrastructure performance of pathway articles. By generating navigation routes based on infrastructure performance of pathway articles, a driver or automated vehicle may make driving decisions and/or perform vehicle operations that account for varying levels of infrastructure performance. Because infrastructure performance (e.g., brightness of a roadway sign or whiteness of a pavement marking) may affect driving decisions made by an automated vehicle or driver, infrastructure performance may affect roadway safety for drivers, pedestrians, custodians, and other entities associated with a roadway. Accordingly, by selecting a navigation route that has relatively better infrastructure performance than other navigation routes, techniques of this disclosure may improve roadway safety for drivers, pedestrians, custodians, and other entities associated with a roadway.

To select navigation routes in accordance with techniques of this disclosure, a computing device may receive one or more infrastructure performance values. The infrastructure performance values may indicate infrastructure performance of the pathway article and may correspond to a roadway portion. The computing device may determine, based at least in part on the one or more infrastructure performance values, a navigation route comprising a set of roadway portions from an initial location to a subsequent location. In some examples, the computing device may perform at least one operation based at least in part on the navigation route comprising the set of roadway portions from the initial location to the subsequent location. For example, the computing device may display a map that visualizes the navigation route or a set of selectable, graphical indicators that correspond to different possible navigation routes.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram illustrating an example system 100 in accordance with techniques of this disclosure.

FIG. 2 is a block diagram illustrating an example computing device, in accordance with one or more aspects of the present disclosure.

FIG. 3 is a block diagram illustrating an example computing device, in accordance with one or more aspects of the present disclosure.

FIG. 4 is a flow diagram illustrating example operations of a computing device for predicting infrastructure performance, in accordance with one or more techniques of this disclosure.

FIG. 5 is a flow diagram illustrating example operations of a computing device for predicting infrastructure performance, in accordance with one or more techniques of this disclosure.

FIG. 6 is a conceptual diagram of infrastructure performance data that may be used to generate maps based on predicted infrastructure performance, in accordance with techniques of this disclosure.

FIG. 7 is a conceptual diagram of infrastructure performance data that may be used with a model to predict infrastructure performance, in accordance with techniques of this disclosure.

FIG. 8 illustrates maps that may be generated by a computing device for infrastructure performance, in accordance with techniques of this disclosure.

FIG. 9 is a conceptual diagram of infrastructure performance data that may be used with a model to generate navigation routes, in accordance with techniques of this disclosure.

FIG. 10 illustrates graphical user interfaces generated by a computing device for infrastructure performance, in accordance with techniques of this disclosure.

FIG. 11 illustrates a graphical user interface generated by a computing device for infrastructure performance, in accordance with techniques of this disclosure.

FIG. 12 illustrates a graphical user interface generated by a computing device for infrastructure performance, in accordance with techniques of this disclosure.

FIG. 13 illustrates a graphical user interface generated by a computing device for infrastructure performance, in accordance with techniques of this disclosure.

FIG. 14 illustrates a graphical user interface generated by a computing device for infrastructure performance, in accordance with techniques of this disclosure.

FIG. 15 illustrates a graphical user interface generated by a computing device for current infrastructure performance, in accordance with techniques of this disclosure.

FIG. 16 illustrates a graphical user interface generated by a computing device for predicted infrastructure performance, in accordance with techniques of this disclosure.

### DETAILED DESCRIPTION

Even with advances in autonomous driving technology, infrastructure, including vehicle roadways, may have a long transition period during which vehicles with advanced Automated Driver Assist Systems (ADAS), and traditional fully human operated vehicles share the road. Some practical constraints may make this transition period decades long, such as the service life of vehicles currently on the road, the capital invested in current infrastructure and the cost of replacement, and the time to manufacture, distribute, and install fully autonomous vehicles and infrastructure.

Autonomous vehicles and ADAS, which may be referred to as semi-autonomous vehicles, may use various sensors to perceive the environment, infrastructure, and other objects around the vehicle. These various sensors combined with onboard computer processing may allow the automated system to perceive complex information and respond to it more quickly than a human driver. In this disclosure, a vehicle may include any vehicle with or without sensors, such as a vision system, to interpret a vehicle pathway. A vehicle with vision systems or other sensors that takes cues from the vehicle pathway may be called a pathway-article assisted vehicle (PAAV). Some examples of PAAVs may include the fully autonomous vehicles and ADAS equipped vehicles mentioned above, as well as unmanned aerial vehicles (UAV) (aka drones), human flight transport devices, underground pit mining ore carrying vehicles, forklifts, factory part or tool transport vehicles, ships and other watercraft and similar vehicles. A vehicle pathway may be a road, highway, a warehouse aisle, factory floor or a pathway not connected to the earth's surface. The vehicle pathway may include portions not limited to the pathway itself. In the example of a road, the pathway may include the road shoulder, physical structures near the pathway such as toll booths, railroad crossing equipment, traffic lights, the sides of a mountain, guardrails, and generally encompassing any other properties or characteristics of the pathway or objects/structures in proximity to the pathway. This will be described in more detail below.

In general, a pathway article may be any article or object embodied, attached, used, or placed at or near a pathway. For instance, a pathway article may be embodied, attached, used, or placed at or near a vehicle, pedestrian, micromobility device (e.g., scooter, food-delivery device, drone, etc.), pathway surface, intersection, building, or other area or object of a pathway. Examples of pathway articles include, but are not limited to signs, pavement markings, temporary traffic articles (e.g., cones, barrels), conspicuity tape, vehicle components, human apparel, stickers, or any other object embodied, attached, used, or placed at or near a pathway.

A pathway article, such as an enhanced sign, in accordance with the techniques of this disclosure may include an article message on the physical surface of the pathway article. In this disclosure, an article message may include images, graphics, characters, such as numbers or letters or any combination of characters, symbols or non-characters. An article message may include human-perceptible information and machine-perceptible information. Human-perceptible information may include information that indicates one or more first characteristics of a vehicle pathway primary information, such as information typically intended to be interpreted by human drivers. In other words, the human-perceptible information may provide a human-perceptible representation that is descriptive of at least a portion of the vehicle pathway. As described herein, human-perceptible information may generally refer to information that indicates a general characteristic of a vehicle pathway and that is intended to be interpreted by a human driver. For example, the human-perceptible information may include words (e.g., “dead end” or the like), symbols or graphics (e.g., an arrow indicating the road ahead includes a sharp turn). Human-perceptible information may include the color of the article message or other features of the pathway article, such as the border or background color. For example, some background colors may indicate information only, such as “scenic overlook” while other colors may indicate a potential hazard.

In some instances, the human-perceptible information may correspond to words or graphics included in a specification. For example, in the United States (U.S.), the human-perceptible information may correspond to words or symbols included in the Manual on Uniform Traffic Control Devices (MUTCD), which is published by the U.S. Department of Transportation (DOT) and includes specifications for many conventional signs for roadways. Other countries have similar specifications for traffic control symbols and devices. In some examples, the human-perceptible information may be referred to as primary information.

An enhanced sign may also include second, additional information that may be interpreted by a PAAV. As described herein, second information or machine-perceptible information may generally refer to additional detailed characteristics of the vehicle pathway. The machine-perceptible information is configured to be interpreted by a PAAV, but in some examples, may be interpreted by a human driver. In other words, machine-perceptible information may include a feature of the graphical symbol that is a computer-interpretable visual property of the graphical symbol. In some examples, the machine-perceptible information may relate to the human-perceptible information, e.g., provide additional context for the human-perceptible information. In an example of an arrow indicating a sharp turn, the human-perceptible information may be a general representation of an arrow, while the machine-perceptible information may provide an indication of the particular shape of the turn including the turn radius, any incline of the roadway, a distance from the sign to the turn, or the like. The additional information may be visible to a human operator; however, the additional information may not be readily interpretable by the human operator, particularly at speed. In other examples, the additional information may not be visible to a human operator, but may still be machine readable and visible to a vision system of a PAAV. In some examples, an enhanced sign may be considered an optically active article.

Redundancy and security may be of concern for a partially and fully autonomous vehicle infrastructure. A blank highway approach to an autonomous infrastructure, i.e. one in which there is no signage or markings on the road and all vehicles are controlled by information from the cloud, may be susceptible to hackers, terroristic ill intent, and unintentional human error. For example, GPS signals can be spoofed to interfere with drone and aircraft navigation. Pathway articles of this disclosure may provide local, onboard redundant validation of information received from GPS and the cloud. Pathway articles of this disclosure may provide additional information to autonomous systems in a manner which is at least partially perceptible by human drivers. Therefore, the techniques of this disclosure may provide solutions that may support the long-term transition to a fully autonomous infrastructure because it can be implemented in high impact areas first and expanded to other areas as budgets and technology allow.

Hence, pathway articles of this disclosure, such as an enhanced sign, may provide additional information that may be processed by the onboard computing systems of the vehicle, along with information from the other sensors on the vehicle that are interpreting the vehicle pathway. The pathway articles of this disclosure may also have advantages in applications such as for vehicles operating in warehouses, factories, airports, airways, waterways, underground or pit mines and similar locations.

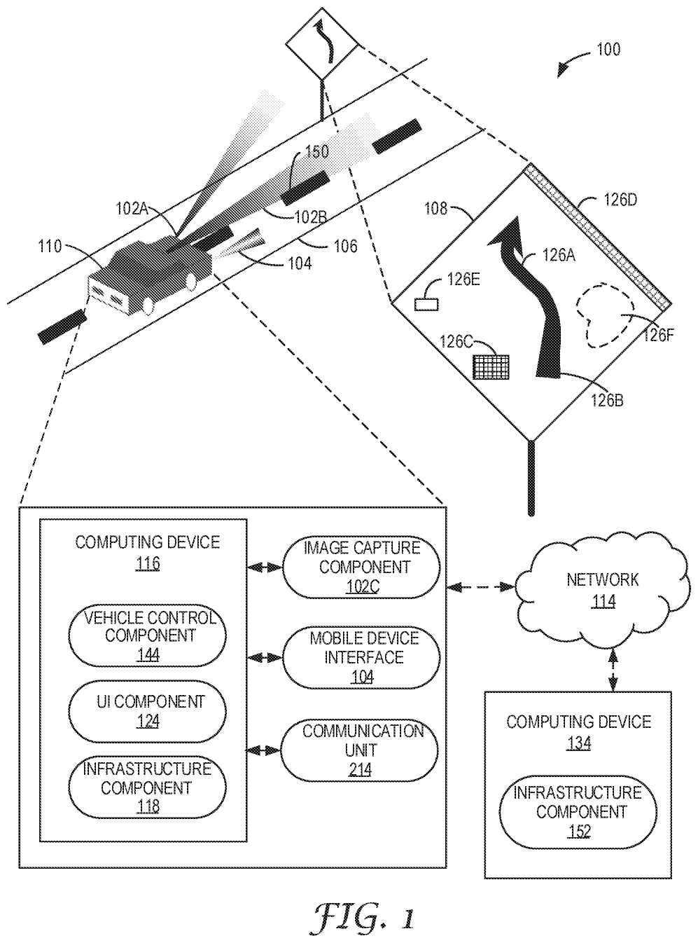

FIG. 1 is a block diagram illustrating an example system 100 in accordance with techniques of this disclosure. As described herein, PAAV generally refers to a vehicle with a vision system, along with other sensors, that may interpret the vehicle pathway and the vehicle's environment, such as other vehicles or objects. A PAAV may interpret information from the vision system and other sensors, make decisions and take actions to navigate the vehicle pathway.

As shown in FIG. 1, system 100 includes PAAV 110 that may operate on vehicle pathway 106 and that includes image capture devices 102A and 102B and computing device 116. Any number of image capture devices may be possible. The illustrated example of system 100 also includes one or more pathway articles as described in this disclosure, such as enhanced sign 108 and pavement marking 150 to name only a few examples.

As noted above, PAAV 110 of system 100 may be an autonomous or semi-autonomous vehicle, such as an ADAS. In some examples PAAV 110 may include occupants that may take full or partial control of PAAV 110. PAAV 110 may be any type of vehicle designed to carry passengers or freight including small electric powered vehicles, large trucks or lorries with trailers, vehicles designed to carry crushed ore within an underground mine, or similar types of vehicles. PAAV 110 may include lighting, such as headlights in the visible light spectrum as well as light sources in other spectrums, such as infrared. PAAV 110 may include other sensors such as radar, sonar, lidar, GPS and communication links for the purpose of sensing the vehicle pathway, other vehicles in the vicinity, environmental conditions around the vehicle and communicating with infrastructure. For example, a rain sensor may operate the vehicles windshield wipers automatically in response to the amount of precipitation, and may also provide inputs to the onboard computing device 116.

As shown in FIG. 1, PAAV 110 of system 100 may include image capture devices 102A and 102B, collectively referred to as image capture devices 102. Image capture devices 102 may convert light or electromagnetic radiation sensed by one or more image capture sensors into information, such as digital image or bitmap comprising a set of pixels. Each pixel may have chrominance and/or luminance components that represent the intensity and/or color of light or electromagnetic radiation. In general, image capture devices 102 may be used to gather information about a pathway. Image capture devices 102 may send image capture information to computing device 116 via image capture component 102C. Image capture devices 102 may capture lane markings, centerline markings, edge of roadway or shoulder markings, as well as the general shape of the vehicle pathway. The general shape of a vehicle pathway may include turns, curves, incline, decline, widening, narrowing or other characteristics. Image capture devices 102 may have a fixed field of view or may have an adjustable field of view. An image capture device with an adjustable field of view may be configured to pan left and right, up and down relative to PAAV 110 as well as be able to widen or narrow focus. In some examples, image capture devices 102 may include a first lens and a second lens.

Image capture devices 102 may include one or more image capture sensors and one or more light sources. In some examples, image capture devices 102 may include image capture sensors and light sources in a single integrated device. In other examples, image capture sensors or light sources may be separate from or otherwise not integrated in image capture devices 102. As described above, PAAV 110 may include light sources separate from image capture devices 102. Examples of image capture sensors within image capture devices 102 may include semiconductor charge-coupled devices (CCD) or active pixel sensors in complementary metal-oxide-semiconductor (CMOS) or N-type metal-oxide-semiconductor (NMOS, Live MOS) technologies. Digital sensors include flat panel detectors. In one example, image capture devices 102 includes at least two different sensors for detecting light in two different wavelength spectrums.

In some examples, one or more light sources 104 include a first source of radiation and a second source of radiation. In some embodiments, the first source of radiation emits radiation in the visible spectrum, and the second source of radiation emits radiation in the near infrared spectrum. In other embodiments, the first source of radiation and the second source of radiation emit radiation in the near infrared spectrum. As shown in FIG. 1 one or more light sources 104 may emit radiation in the near infrared spectrum.

In some examples, image capture devices 102 captures frames at 50 frames per second (fps). Other examples of frame capture rates include 60, 30 and 25 fps. It should be apparent to a skilled artisan that frame capture rates are dependent on application and different rates may be used, such as, for example, 100 or 200 fps. Factors that affect required frame rate are, for example, size of the field of view (e.g., lower frame rates can be used for larger fields of view, but may limit depth of focus), and vehicle speed (higher speed may require a higher frame rate).

In some examples, image capture devices 102 may include at least more than one channel The channels may be optical channels. The two optical channels may pass through one lens onto a single sensor. In some examples, image capture devices 102 includes at least one sensor, one lens and one band pass filter per channel The band pass filter permits the transmission of multiple near infrared wavelengths to be received by the single sensor. The at least two channels may be differentiated by one of the following: (a) width of band (e.g., narrowband or wideband, wherein narrowband illumination may be any wavelength from the visible into the near infrared); (b) different wavelengths (e.g., narrowband processing at different wavelengths can be used to enhance features of interest, such as, for example, an enhanced sign of this disclosure, while suppressing other features (e.g., other objects, sunlight, headlights); (c) wavelength region (e.g., broadband light in the visible spectrum and used with either color or monochrome sensors); (d) sensor type or characteristics; (e) time exposure; and (f) optical components (e.g., lensing).

In some examples, image capture devices 102A and 102B may include an adjustable focus function. For example, image capture device 102B may have a wide field of focus that captures images along the length of vehicle pathway 106, as shown in the example of FIG. 1. Computing device 116 may control image capture device 102A to shift to one side or the other of vehicle pathway 106 and narrow focus to capture the image of enhanced sign 108, or other features along vehicle pathway 106. The adjustable focus may be physical, such as adjusting a lens focus, or may be digital, similar to the facial focus function found on desktop conferencing cameras. In the example of FIG. 1, image capture devices 102 may be communicatively coupled to computing device 116 via image capture component 102C. Image capture component 102C may receive image information from the plurality of image capture devices, such as image capture devices 102, perform image processing, such as filtering, amplification and the like, and send image information to computing device 116.

Other components of PAAV 110 that may communicate with computing device 116 may include image capture component 102C, described above, mobile device interface 104, and communication unit 214. In some examples image capture component 102C, mobile device interface 104, and communication unit 214 may be separate from computing device 116 and in other examples may be a component of computing device 116.

Mobile device interface 104 may include a wired or wireless connection to a smartphone, tablet computer, laptop computer or similar device. In some examples, computing device 116 may communicate via mobile device interface 104 for a variety of purposes such as receiving traffic information, address of a desired destination or other purposes. In some examples computing device 116 may communicate to external networks 114, e.g. the cloud, via mobile device interface 104. In other examples, computing device 116 may communicate via communication units 214.

One or more communication units 214 of computing device 116 may communicate with external devices by transmitting and/or receiving data. For example, computing device 116 may use communication units 214 to transmit and/or receive radio signals on a radio network such as a cellular radio network or other networks, such as networks 114. In some examples communication units 214 may transmit and receive messages and information to other vehicles, such as information interpreted from enhanced sign 108. In some examples, communication units 214 may transmit and/or receive satellite signals on a satellite network such as a Global Positioning System (GPS) network.

In the example of FIG. 1, computing device 116 includes vehicle control component 144 and user interface (UI) component 124 and an infrastructure component 118. Components 118, 144, and 124 may perform operations described herein using software, hardware, firmware, or a mixture of both hardware, software, and firmware residing in and executing on computing device 116 and/or at one or more other remote computing devices. In some examples, components 118, 144 and 124 may be implemented as hardware, software, and/or a combination of hardware and software.

Computing device 116 may execute components 118, 124, 144 with one or more processors. Computing device 116 may execute any of components 118, 124, 144 as or within a virtual machine executing on underlying hardware. Components 118, 124, 144 may be implemented in various ways. For example, any of components 118, 124, 144 may be implemented as a downloadable or pre-installed application or “app.” In another example, any of components 118, 124, 144 may be implemented as part of an operating system of computing device 116. Computing device 116 may include inputs from sensors not shown in FIG. 1 such as engine temperature sensor, speed sensor, tire pressure sensor, air temperature sensors, an inclinometer, accelerometers, light sensor, and similar sensing components.

UI component 124 may include any hardware or software for communicating with a user of PAAV 110. In some examples, UI component 124 includes outputs to a user such as displays, such as a display screen, indicator or other lights, audio devices to generate notifications or other audible functions. UI component 24 may also include inputs such as knobs, switches, keyboards, touch screens or similar types of input devices.

Vehicle control component 144 may include for example, any circuitry or other hardware, or software that may adjust one or more functions of the vehicle. Some examples include adjustments to change a speed of the vehicle, change the status of a headlight, changing a damping coefficient of a suspension system of the vehicle, apply a force to a steering system of the vehicle or change the interpretation of one or more inputs from other sensors. For example, an IR capture device may determine an object near the vehicle pathway has body heat and change the interpretation of a visible spectrum image capture device from the object being a non-mobile structure to a possible large animal that could move into the pathway. Vehicle control component 144 may further control the vehicle speed as a result of these changes. In some examples, the computing device initiates the determined adjustment for one or more functions of the PAAV based on the machine-perceptible information in conjunction with a human operator that alters one or more functions of the PAAV based on the human-perceptible information.

Infrastructure component 118 may receive infrastructure information about vehicle pathway 106 and determine one or more characteristics of vehicle pathway 106. For example, infrastructure component 118 may receive images from image capture devices 102 and/or other information from systems of PAAV 110 in order to make determinations about characteristics of vehicle pathway 106. As described below, in some examples, infrastructure component 118 may transmit such determinations to vehicle control component 144, which may control PAAV 110 based on the information received from interpretation component. In other examples, computing device 116 may use information from infrastructure component 118 to generate notifications for a user of PAAV 110, e.g., notifications that indicate a characteristic or condition of vehicle pathway 106.

Enhanced sign 108 represents one example of a pathway article and may include reflective, non-reflective, and/or retroreflective sheet applied to a base surface. An article message, such as but not limited to characters, images, and/or any other information, may be printed, formed, or otherwise embodied on the enhanced sign 108. The reflective, non-reflective, and/or retroreflective sheet may be applied to a base surface using one or more techniques and/or materials including but not limited to: mechanical bonding, thermal bonding, chemical bonding, or any other suitable technique for attaching retroreflective sheet to a base surface. A base surface may include any surface of an object (such as described above, e.g., an aluminum plate) to which the reflective, non-reflective, and/or retroreflective sheet may be attached. An article message may be printed, formed, or otherwise embodied on the sheeting using any one or more of an ink, a dye, a thermal transfer ribbon, a colorant, a pigment, and/or an adhesive coated film. In some examples, content is formed from or includes a multi-layer optical film, a material including an optically active pigment or dye, or an optically active pigment or dye.

Enhanced sign 108 in FIG. 1 includes article message 126A-126F (collectively “article message 126”). Article message 126 may include a plurality of components or features that provide information on one or more characteristics of a vehicle pathway. Article message 126 may include primary information (interchangeably referred to herein as human-perceptible information) that indicates general information about vehicle pathway 106. Article message 126 may include additional information (interchangeably referred to herein as machine-perceptible information) that may be configured to be interpreted by a PAAV.

In the example of FIG. 1, one component of article message 126 includes arrow 126A, a graphical symbol. The general contour of arrow 126A may represent primary information that describes a characteristic of vehicle pathway 106, such as an impending curve. For example, features arrow 126A may include the general contour of arrow 126A and may be interpreted by both a human operator of PAAV 110 as well as computing device 116 onboard PAAV 110.

In some examples, according to aspects of this disclosure, article message 126 may include a machine-readable fiducial marker 126C. The fiducial marker may also be referred to as a fiducial tag. Fiducial tag 126C may represent additional information about characteristics of pathway 106, such as the radius of the impending curve indicated by arrow 126A or a scale factor for the shape of arrow 126A. In some examples, fiducial tag 126C may indicate to computing device 116 that enhanced sign 108 is an enhanced sign rather than a conventional sign. In other examples, fiducial tag 126C may act as a security element that indicates enhanced sign 108 is not a counterfeit.

In other examples, other portions of article message 126 may indicate to computing device 116 that a pathway article is an enhanced sign. For example, according to aspects of this disclosure, article message 126 may include a change in polarization in area 126F. In this example, computing device 116 may identify the change in polarization and determine that article message 126 includes additional information regarding vehicle pathway 106.

In accordance with this disclosure, some techniques and systems are generally directed to predicting future infrastructure performance of a pathway article based on data for infrastructure performance features that influence predicted infrastructure performance at a future point in time. In some instances, infrastructure performance of a pathway article may refer to the chromaticity or luminosity of light that is reflected from or corresponds to a pathway article. For example, infrastructure performance may be represented as a cap-Y value for a pavement marking or a retroreflected light value for a retroreflective sign. Rather than simply inventorying conditions of a roadway (e.g., potholes, heaves, or physical obstructions to visibility of the roadway) that are external to the pathway article or merely collecting current infrastructure performance, techniques of this disclosure may predict infrastructure performance at a future point in time. By predicting infrastructure performance at a future point in time, a roadway custodian or PAAV may identify or determine that unsafe roadway conditions may occur prior to the unsafe roadway conditions actually occurring. In this way, techniques of this disclosure that predict infrastructure performance at a future point in time may improve roadway safety for drivers, pedestrians, custodians, and other entities associated with a roadway.

To predict infrastructure performance at a future point in time, a computing device may receive one or more sets of infrastructure performance data for a pathway article that correspond respectively to infrastructure performance features. The infrastructure performance features may influence predicted infrastructure performance of the pathway article at a future point in time and the infrastructure performance data may correspond to a roadway portion. The computing device may generate, based at least in part on applying the one or more sets of infrastructure performance data to a model, at least one infrastructure performance prediction value that indicates predicted infrastructure performance of the pathway article at the future point in time. The future point in time may occur after a time that the one or more sets of infrastructure performance data are applied to the model. In some examples, the model may be trained based on prior instances of infrastructure performance that correspond to defined time durations, such as a length of time between an installation time of a pathway article and a measurement time of the infrastructure performance value that occurs after the installation time. In this way, infrastructure performance data that indicates degradation of performance over defined periods of time may be used to configure the model to predict how infrastructure performance will degrade in the future. The computing device may perform operations based at least in part on the infrastructure performance prediction value that indicates the predicted infrastructure performance of the pathway article at the future point in time. For example, the computing device may send infrastructure performance prediction values to PAAVs to influence driving operations or the computing device may generate notifications for roadway custodians when infrastructure performance prediction values fail to satisfy roadway safety thresholds.

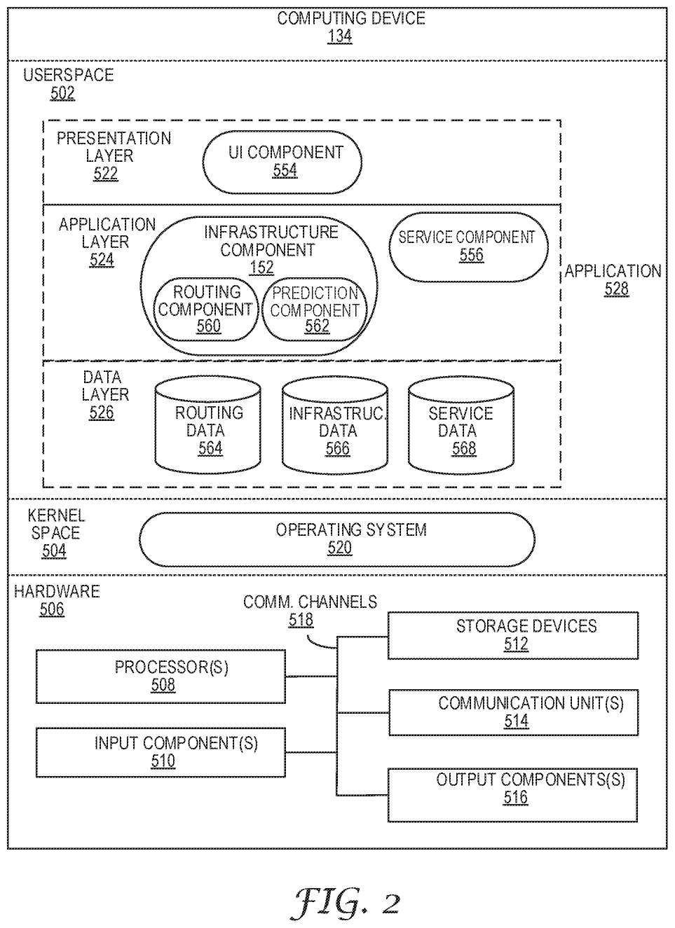

In the example of FIG. 1, computing device 134 may include infrastructure component 152 as further described in FIG. 2 and computing device 116 may include infrastructure component 118, each of which may perform one or more functions or operations in accordance with techniques of this disclosure. In some examples, the one or more functions or operations may be performed on a single computing device or distributed using multiple computing devices, such as via distributed computing using network 114 and computing devices 116 and 134. For purposes of illustration only, techniques of this disclosure are described with respect to infrastructure component 152.

Infrastructure component 152 may receive one or more sets of infrastructure performance data that correspond respectively to infrastructure performance features. The infrastructure performance features may influence predicted infrastructure performance of a pathway article at a future point in time. Examples of infrastructure performance features may include, but are not limited to a weather condition, snow-plowing, ambient light, historical traffic, real-time traffic, an automated driving characteristic from a probe vehicle, a speed limit, a type or age of pathway article, a pathway article degradation metric, an environmental condition present at a time of installation of a pathway article, a roadway construction condition, a performance of a pathway article as sensed by a sensor that sensed the pathway article, to name only a few examples. In some examples, infrastructure performance features may represent types of data usable to determine performance or degradation of performance of pathway articles. Infrastructure performance features may influence predicted infrastructure performance of a pathway article at a future point in time, such as by degrading the infrastructure performance of a pathway article. For example, temperature, light, physical impacts or abrasions, humidity or wetness, or any other physical or energy-based exposures may degrade performance of the pathway article.

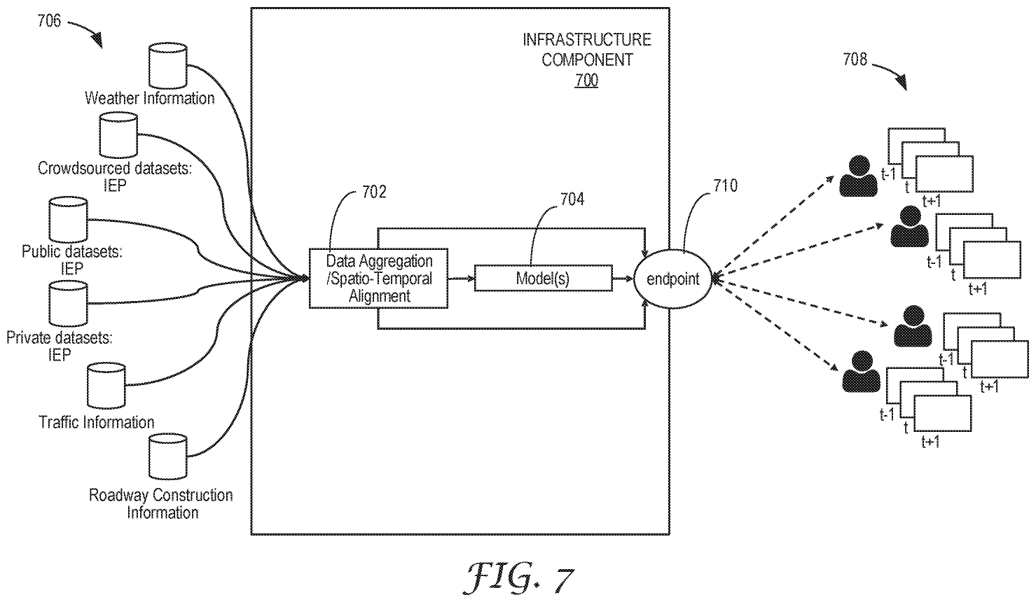

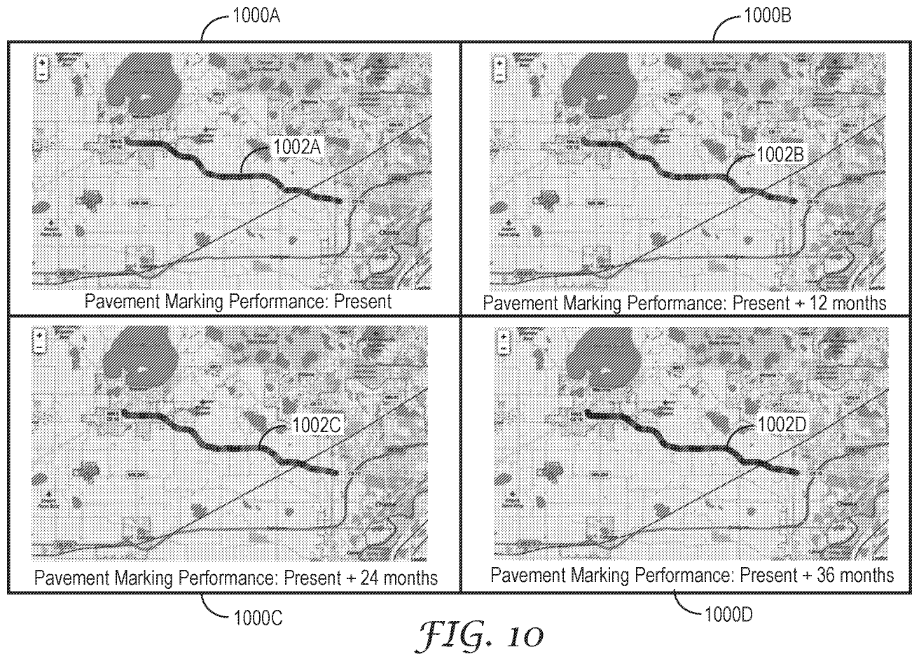

Infrastructure performance data may correspond respectively to infrastructure performance features. Infrastructure performance data may be recorded from one or more sensors, may be human-generated and/or may be otherwise machine-generated by one or more computing devices. Infrastructure performance data may represent instances of data that correspond to a particular infrastructure performance feature. For example, a weather condition may be an infrastructure performance feature, and infrastructure performance data for this particular feature may include a set of values, such as but not limited to: {pathway article unique identifier, pathway article type, snow, 2 cm, 12/23/2019, 44.949418, −92.9992127}. In other examples, the infrastructure performance data may be {snow, 2 cm, 12/23/2019, 44.949418, −92.9992127} and a separate representation of the pathway articles at or near the location of the snow may used by infrastructure component 152 to determine which pathway articles are associated with particular infrastructure performance data. For example, the separate representation of infrastructure performance data characterizing an pathway article may include, but is not limited to: {pathway article unique identifier, pathway article type, installation date . . . }. As another example, a speed limit may be an infrastructure performance feature, and infrastructure performance data for this particular feature may include a set of values, such as but not limited to: {55 miles per hour, 44.949418, −92.9992127}. Any number of values may be possible for any instance of infrastructure performance data that corresponds to an infrastructure performance feature. FIGS. 7 and 10, and their corresponding descriptions, illustrate and describe different sources of infrastructure performance data that may be used by infrastructure component 152.

Using the infrastructure performance data, infrastructure component 152 may generate, based at least in part on applying the one or more sets of infrastructure performance data to a model, at least one infrastructure performance prediction value that indicates predicted infrastructure performance at the future point in time. The future point in time may occur after a time that the one or more sets of infrastructure performance data are applied to the model used by infrastructure component 152. Example models used or implemented by infrastructure component 152 may use techniques such as, but are not limited to: supervised and unsupervised learning techniques, such as neural networks and deep learning. Other techniques that may be used in accordance with techniques of this disclosure include but are not limited to Bayesian algorithms, clustering algorithms, decision-tree algorithms, regularization algorithms, regression algorithms, instance-based algorithms, artificial neural network algorithms, deep learning algorithms, dimensionality reduction algorithms and the like. Various examples of specific algorithms include Bayesian Linear Regression, Boosted Decision Tree Regression, and Neural Network Regression, Back Propagation Neural Networks, the Apriori algorithm, K-Means Clustering, k-Nearest Neighbour (kNN), Learning Vector Quantization (LVQ), Self-Organizing Map (SOM), Locally Weighted Learning (LWL), Ridge Regression, Least Absolute Shrinkage and Selection Operator (LASSO), Elastic Net, and Least-Angle Regression (LARS), Principal Component Analysis (PCA) and Principal Component Regression (PCR).

The model used or implemented by infrastructure component 152 may be trained based on prior instances of infrastructure performance data. The training instances may include associations between respective infrastructure performance data and respective infrastructure performance values. An infrastructure performance value may indicate infrastructure performance. Infrastructure performance may characterize or be a characteristic of a physical property of an pathway article. Examples of infrastructure performance may include, but are not limited to: chromaticity (e.g., specification of the quality of a color) or luminosity (e.g., specification of the radiated electromagnetic power) of light that corresponds to or is reflected from the pathway article. By training the model based on prior instances of infrastructure performance data that indicate relationships between infrastructure performance values and infrastructure performance data, the model may be configured to output an infrastructure performance value when provided with an input of infrastructure performance data. Because infrastructure performance data may indicate a measured infrastructure performance after some duration of time following installation of the pathway article, the performance or degradation of the pathway article over time is reflected in the corresponding infrastructure performance value. As such, if a measurement of infrastructure performance data is applied to the trained model as input with a future time duration, the trained model may output predicted infrastructure performance at the future point in time.

Predicted infrastructure performance may be represented as a predicted infrastructure performance value. A predicted infrastructure performance value may be an infrastructure performance value that is predicted for a future time or following a future time duration. In this way, if an pathway article is exposed over a particular time duration to similar conditions for infrastructure performance features as other pathway articles that were included in the training set used to configure the model for the same time duration, the model may generate a predicted infrastructure performance value that indicates the predicted infrastructure performance.

Information generated by infrastructure component 152, including infrastructure performance values, may be used to perform one or more operations. For example, infrastructure component 152 may generate one or more outputs. Example outputs may include visual, audible, or haptic outputs. Other examples of outputs may include sending one or more messages based on the information generated by infrastructure component 152 to one or more other remote computing devices.

Other example operations may include processing the infrastructure performance values. For example, computing device 134 may perform the at least one operation based at least in part on data indicating at least one of an accident or a near-miss of the accident at a portion of a roadway. As an example, computing device 134 may output one or more correlations, associations, or statistics that indicate relationships between accidents or near-misses of accidents and infrastructure performance values and/or predicted infrastructure performance values. In other examples, the example operations may include generating a map that indicates different infrastructure performance prediction values at different locations. In still other examples, the example operations may generate for a notification in response to determining that the infrastructure performance prediction value satisfies a threshold.

In accordance with this disclosure, some techniques and systems are generally directed to selecting navigation routes based on infrastructure performance values that indicate infrastructure performance of pathway articles. In some instances, infrastructure performance of a pathway article may refer to the chromaticity or luminosity of light that is reflected from or corresponds to a pathway article. For example, infrastructure performance may be represented as a cap-Y value for a pavement marking or a retroreflected light value for a retroreflective sign. Rather than generating navigation routes between departure and destination location based on distance or congestion, techniques of this disclosure may generate navigation routes based on infrastructure performance of pathway articles. By generating navigation routes based on infrastructure performance of pathway articles, a driver or automated vehicle may make driving decisions and/or perform vehicle operations that account for varying levels of infrastructure performance. Because infrastructure performance (e.g., brightness of a roadway sign or whiteness of a pavement marking) may affect driving decisions made by an automated vehicle or driver, infrastructure performance may affect roadway safety for drivers, pedestrians, custodians, and other entities associated with a roadway. Accordingly, by selecting a navigation route that has relatively better infrastructure performance than other navigation routes, techniques of this disclosure may improve roadway safety for drivers, pedestrians, custodians, and other entities associated with a roadway.

To select navigation routes in accordance with techniques of this disclosure, a computing device may receive one or more infrastructure performance values. The infrastructure performance values may indicate infrastructure performance of the pathway article and may correspond to a roadway portion. The computing device may determine, based at least in part on the one or more infrastructure performance values, a navigation route comprising a set of roadway portions from an initial location to a subsequent location. In some examples, the computing device may perform at least one operation based at least in part on the navigation route comprising the set of roadway portions from the initial location to the subsequent location. For example, the computing device may display a map that visualizes the navigation route or a set of selectable, graphical indicators that correspond to different possible navigation routes.

In the example of FIG. 1, computing device 134 may include infrastructure component 152 as further described in FIG. 2 and computing device 116 may include infrastructure component 118, each of which may perform one or more functions or operations in accordance with techniques of this disclosure. In some examples, the one or more functions or operations may be performed on a single computing device or distributed using multiple computing devices, such as via distributed computing using network 114 and computing devices 116 and 134. For purposes of illustration only, techniques of this disclosure are described with respect to infrastructure component 152.

In some examples, infrastructure component 152 may receive a request or user input to generate a navigation route from an initial location to a subsequent location. Infrastructure component 152 may select one or more infrastructure performance values that are indicative of infrastructure performance of the pathway article and the infrastructure performance values correspond to a roadway portion. The initial and subsequent locations may be departure and destination locations and/or intermediate locations residing on the path between departure and destination locations. As described above, an infrastructure performance value may indicate infrastructure performance. Infrastructure performance may characterize or be a characteristic of a physical property of a pathway article. Examples of infrastructure performance may include, but are not limited to: chromaticity (e.g., specification of the quality of a color) or luminosity (e.g., specification of the radiated electromagnetic power) of light that corresponds to or is reflected from the pathway article. In some examples, luminosity may be a retroreflectivity value. In some examples, a contrast value may be a ration between chromaticity values. In some examples, a retroreflectivity value may be measured based on whether the pathway article is wet or dry (e.g., a wet retroreflectivity value or a dry retroreflectivity value).

Infrastructure performance values may be access by infrastructure component 152 from one or more sources. For example, vehicles such as PAAV 110 may include an image capture component 102C or other sensors that generate infrastructure performance values, which are sent via network 114 to computing device 134. One or more other PAAVs may similarly send infrastructure performance values to computing device 134, which may be used by infrastructure component 152. In some examples, historical infrastructure performance values may be selected or otherwise retrieved from research databases, roadway databases, or any other sources.

Infrastructure component 152 may determine, based at least in part on the infrastructure performance values, a navigation route comprising a plurality of roadway portions from an initial location to a subsequent location. In some examples, infrastructure component 152 may implement one or more navigation route generation techniques described in the following publications, each of which is hereby incorporated by reference herein in its entirety: Flinsenberg, I. C. M. (2004). Route planning algorithms for car navigation Eindhoven: Technische Universiteit Eindhoven DOI: 10.6100/IR580449; Peter Sanders and Dominik Schultes. 2007. Engineering fast route planning algorithms. In Proceedings of the 6th international conference on Experimental algorithms (WEA'07), Camil Demetrescu (Ed.). Springer-Verlag, Berlin, Heidelberg, 23-36; Storandt, Sabine Algorithms for vehicle navigation. PhD thesis, Universitat Stuttgart, February 2013. For example, infrastructure component 152 may represent a roadway portion as an edge in a graph. In some examples, an edge may have one or more cost values. A cost value may represent a distance or length of the roadway portion, a congestion level for the roadway portion, an autonomous driving level, and/or any other characteristic or constraint. A roadway portion may be some portion of a roadway. A set of roadway portions may be connected by vertices to form a graph. A path may be a continuous set of edges (connected by vertices) from an initial vertex to a subsequent vertex. Multiple paths may be possible through the graph, where each path may represent a navigation route comprising a set of roadway portions.

To generate navigation route, infrastructure component 152 may determine, based at least in part on the infrastructure performance values, a navigation route comprising a set of roadway portions from an initial location to a subsequent location. To generate the navigation route, infrastructure component 152 may determine one or more roadway portion sets. Each respective roadway portion set in the one or more roadway portion sets may include a respective plurality of roadway portions that form a complete path from the initial location to the subsequent location. For at least one roadway portion set, infrastructure component 152 may determine a respective infrastructure performance value for each respective roadway portion in the at last one roadway portion set. For example, infrastructure component 152 may assign an infrastructure performance value for a roadway portion as a cost value for the edge that represents the roadway portion. In this way, each different path through a graph comprised of edges representing roadway portions and cost values representing infrastructure performance values may have a different cumulative or aggregate cost.

Infrastructure component 152 may select, based at least in part on the respective infrastructure performance values, at least one roadway portion set as the navigation route. Any number of techniques may be used to select the at least one roadway portion set as the navigation route. For example, infrastructure component 152 may select, based on cost values of edges, the path with the maximum total cost, minimum total cost, lowest variance across edges in the path, or any other selection function or criterion.

Infrastructure component 152, may perform at least one operation based at least in part on the navigation route comprising the plurality of roadway portions from the initial location to the subsequent location. For example, infrastructure component 152 may send data based on or representing the plurality of roadway portions from the initial location to the subsequent location to one or more other computing devices, such as computing device 116. Infrastructure component 152 may generate a map representing the plurality of roadway portions from the initial location to the subsequent location. In some examples, infrastructure component 152 may generate output based at least in part on the plurality of roadway portions from the initial location to the subsequent location. In some examples, output may be visual, haptic, or audio output and may correspond to particular roadway portions in the plurality of roadway portions.

FIG. 2 is a block diagram illustrating an example computing device, in accordance with one or more aspects of the present disclosure. FIG. 2 illustrates only one example of a computing device, which in FIG. 2 is computing device 134 of FIG. 1. Many other examples of computing device 134 may be used in other instances and may include a subset of the components included in example computing device 134 or may include additional components not shown example computing device 134 in FIG. 2. Computing device 134 may be a remote computing device (e.g., a server computing device) from computing device 116 in FIG. 1.

In some examples, computing device 134 may be a server, tablet computing device, smartphone, wrist- or head-worn computing device, laptop, desktop computing device, or any other computing device that may run a set, subset, or superset of functionality included in application 228. In some examples, computing device 134 may correspond to computing device 134 depicted in FIG. 1. In other examples, computing device 134 may also be part of a system or device that produces pathway articles.

As shown in the example of FIG. 2, computing device 134 may be logically divided into user space 502, kernel space 504, and hardware 506. Hardware 506 may include one or more hardware components that provide an operating environment for components executing in user space 502 and kernel space 504. User space 502 and kernel space 504 may represent different sections or segmentations of memory, where kernel space 504 provides higher privileges to processes and threads than user space 502. For instance, kernel space 504 may include operating system 520, which operates with higher privileges than components executing in user space 502. In some examples, any components, functions, operations, and/or data may be included or executed in kernel space 504 and/or implemented as hardware components in hardware 506.

As shown in FIG. 2, hardware 506 includes one or more processors 508, input components 510, storage devices 512, communication units 514, and output components 516. Processors 508, input components 510, storage devices 512, communication units 514, and output components 516 may each be interconnected by one or more communication channels 518. Communication channels 518 may interconnect each of the components 508, 510, 512, 514, and 516 for inter-component communications (physically, communicatively, and/or operatively). In some examples, communication channels 518 may include a hardware bus, a network connection, one or more inter-process communication data structures, or any other components for communicating data between hardware and/or software.

One or more processors 508 may implement functionality and/or execute instructions within computing device 134. For example, processors 508 on computing device 134 may receive and execute instructions stored by storage devices 512 that provide the functionality of components included in kernel space 504 and user space 502. These instructions executed by processors 508 may cause computing device 134 to store and/or modify information, within storage devices 512 during program execution. Processors 508 may execute instructions of components in kernel space 504 and user space 502 to perform one or more operations in accordance with techniques of this disclosure. That is, components included in user space 502 and kernel space 504 may be operable by processors 508 to perform various functions described herein.

One or more input components 510 of computing device 134 may receive input. Examples of input are tactile, audio, kinetic, and optical input, to name only a few examples. Input components 510 of computing device 134, in one example, include a mouse, keyboard, voice responsive system, video camera, buttons, control pad, microphone or any other type of device for detecting input from a human or machine. In some examples, input component 510 may be a presence-sensitive input component, which may include a presence-sensitive screen, touch-sensitive screen, etc.

One or more communication units 514 of computing device 134 may communicate with external devices by transmitting and/or receiving data. For example, computing device 134 may use communication units 514 to transmit and/or receive radio signals on a radio network such as a cellular radio network. In some examples, communication units 514 may transmit and/or receive satellite signals on a satellite network such as a Global Positioning System (GPS) network. Examples of communication units 514 include a network interface card (e.g. such as an Ethernet card), an optical transceiver, a radio frequency transceiver, a GPS receiver, or any other type of device that can send and/or receive information. Other examples of communication units 514 may include Bluetooth®, GPS, 3G, 4G, and Wi-Fi® radios found in mobile devices as well as Universal Serial Bus (USB) controllers and the like.

One or more output components 516 of computing device 134 may generate output. Examples of output are tactile, audio, and video output. Output components 516 of computing device 134, in some examples, include a presence-sensitive screen, sound card, video graphics adapter card, speaker, cathode ray tube (CRT) monitor, liquid crystal display (LCD), or any other type of device for generating output to a human or machine. Output components may include display components such as cathode ray tube (CRT) monitor, liquid crystal display (LCD), Light-Emitting Diode (LED) or any other type of device for generating tactile, audio, and/or visual output. Output components 516 may be integrated with computing device 134 in some examples.

In other examples, output components 516 may be physically external to and separate from computing device 134, but may be operably coupled to computing device 134 via wired or wireless communication. An output component may be a built-in component of computing device 134 located within and physically connected to the external packaging of computing device 134 (e.g., a screen on a mobile phone). In another example, a presence-sensitive display may be an external component of computing device 134 located outside and physically separated from the packaging of computing device 134 (e.g., a monitor, a projector, etc. that shares a wired and/or wireless data path with a tablet computer).

One or more storage devices 512 within computing device 134 may store information for processing during operation of computing device 134. In some examples, storage device 512 is a temporary memory, meaning that a primary purpose of storage device 512 is not long-term storage. Storage devices 512 on computing device 134 may configured for short-term storage of information as volatile memory and therefore not retain stored contents if deactivated. Examples of volatile memories include random access memories (RAM), dynamic random access memories (DRAM), static random access memories (SRAM), and other forms of volatile memories known in the art.

Storage devices 512, in some examples, also include one or more computer-readable storage media. Storage devices 512 may be configured to store larger amounts of information than volatile memory. Storage devices 512 may further be configured for long-term storage of information as non-volatile memory space and retain information after activate/off cycles. Examples of non-volatile memories include magnetic hard discs, optical discs, floppy discs, flash memories, or forms of electrically programmable memories (EPROM) or electrically erasable and programmable (EEPROM) memories. Storage devices 512 may store program instructions and/or data associated with components included in user space 502 and/or kernel space 504.

As shown in FIG. 2, application 528 executes in userspace 502 of computing device 134. Application 528 may be logically divided into presentation layer 522, application layer 524, and data layer 526. Application 528 may include, but is not limited to the various components and data illustrated in presentation layer 522, application layer 524, and data layer 526.

Data layer 526 may include one or more datastores. A datastore may store data in structure or unstructured form. Example datastores may be any one or more of a relational database management system, online analytical processing database, table, or any other suitable structure for storing data.

Computing device 134 may include or be communicatively coupled to construction component 517, in the example where computing device 134 is a part of a system or device that produces pathway articles, such as described in relation to computing device 134 in FIG. 1. In other examples, construction component 517 may be included in a remote computing device that is separate from computing device 134, and the remote computing device may or may not be communicatively coupled to computing device 134.

In the example of FIG. 2, prediction component 562 may receive one or more sets of infrastructure performance data that correspond respectively to infrastructure performance features. The infrastructure performance data may be stored as infrastructure data 566, and the infrastructure performance features may influence predicted infrastructure performance of a pathway article at a future point in time. Prediction component 562 may generate, based at least in part on applying the one or more sets of infrastructure performance data to a model, at least one infrastructure performance prediction value that indicates predicted infrastructure performance at the future point in time. The future point in time occurs after a time that the one or more sets of infrastructure performance data are applied to the model. Prediction component 562 may perform at least one operation based at least in part on the infrastructure performance prediction value that indicates the predicted infrastructure performance at the future point in time. For instance, prediction component 562 may cause service component 556 to perform one or more service. In another example, prediction component 562 may cause UI component 554 to generate one or more outputs.

In some examples, prediction component 562 may train one or more models and/or use one or more prior-trained models. Prediction component 562 may use a model configured based on selection of a training set comprising a set of training instances. Each respective training instance may include an association between respective infrastructure performance data and a respective infrastructure performance value. The model may be configured based on, for each training instance in the training set, modification, based on the respective infrastructure performance data and the respective infrastructure performance value, of the model to change an infrastructure performance prediction value predicted by the model in response to subsequent infrastructure performance data applied to the model after the set of training instances is applied to the model. In some examples, the one or more models are configured and/or trained on a different computing device and transferred to computing device 134 to perform the techniques of this disclosure. In some examples, each training instance of the set of training instances comprises a respective infrastructure performance value that is based on a defined time duration, wherein the time duration corresponds to a length of time between an installation time of a pathway article and a measurement time of the infrastructure performance value that occurs after the installation time. In some examples, the infrastructure performance features are indicative of one or more of: a weather condition, snow-plowing, ambient light, historical traffic, real-time traffic, an automated driving characteristic from a probe vehicle, a speed limit, a type or age of pathway article, a pathway article degradation metric, an environmental condition present at a time of installation of a pathway article, a roadway construction condition, a performance of a pathway article as sensed by a sensor that sensed the pathway article. In some examples, predicted infrastructure performance comprises a characteristic indicating at least one of a chromaticity or luminosity of light that corresponds to the pathway article. In some examples, a performance prediction value that indicates predicted infrastructure performance at the future point in time comprises at least one of a retroreflectivity value of a roadway sign or a cap-Y value of a pavement marking.

In some examples, infrastructure performance features do not include features that physically obstruct visibility of the pathway article. In some examples, infrastructure performance features do not include physical features of the roadway that are external to the pathway article. In some examples, the physical features of the roadway that are external to the pathway article comprise one or more of potholes, heaves, cracks, or tar marks.

In some examples, prediction component 562 may select data indicating at least one of an accident or a near-miss of an accident at the portion of the roadway. Such data may be included in infrastructure data 566 or other data sources. Prediction component 562 may select the infrastructure performance prediction value for the portion of the roadway. Prediction component 562 may perform, or may cause other components to perform at least one operation based at least in part on the data indicating the at least one of the accident or the near-miss of the accident at the portion of the roadway and the infrastructure performance prediction value for the portion of the roadway. In other examples, such techniques may also be applied using current infrastructure performance values in the same manner as described above with respect to using infrastructure performance prediction values.

In some examples, prediction component 562 may send the infrastructure performance prediction value to at least one remote computing device. The at least one remote computing device may be included in a vehicle configured to use the infrastructure performance prediction value to operate the vehicle.

In some examples, prediction component 562 may select a set of infrastructure performance prediction values that includes an infrastructure performance prediction value, wherein each respective infrastructure performance prediction value corresponds to a respective roadway portion. Prediction component 562 may determine, based at least in part on the set of infrastructure performance prediction values, a set of portions of roadways. Prediction component 562, wherein to perform the at least one operation, may generate one or more remedial or prescriptive outputs for the set of portions of roadways. The remedial or prescriptive outputs may include recommendations on replacement, positioning, arrangement, selection, removal, or other configurations with respect to pathway articles that are either present or should be present at the roadway portion.

In some examples, prediction component 562 may generate a set of tuples. Each respective tuple comprises at least a respective infrastructure performance prediction value and respective location information for the respective infrastructure performance prediction value. The respective location information may correspond to a respective location of a roadway associated with the respective infrastructure performance prediction value. In some examples, prediction component 562 may generate, based at last in part on the set of tuples, a map that indicates different infrastructure performance prediction values at different locations.

In some examples, prediction component 562 may identify a second roadway portion. Prediction component 562 may select, based at least in part on one or more characteristics of the first portion that satisfy a similarity threshold for one or more characteristics of the second portion, the infrastructure performance prediction value for the first portion. Prediction component 562 may determine, based at least in part on the infrastructure performance prediction value for the first portion, an infrastructure performance prediction value for the second portion. In this way, a particular roadway portion that has not had infrastructure performance values measured may be assigned or associated with one or more infrastructure performance prediction values that are generated for roadway portions that are similar to the particular roadway.

In some examples, prediction component 562 and/or UI component 554 may generate for output, a notification in response to determining that the infrastructure performance prediction value satisfies a threshold.

In some examples, prediction component 562 may construct map layers characterizing the performance of roadway infrastructure elements, such as pavement markings and traffic signs in present as well as future time points. The map construction may be an aggregation layer conveying the output of predictive models representing the elements' performance degradation over time. Prediction component 562 may predict infrastructure materials' performance (such as retro-reflectivity and cap-y) conditioned upon exogenous factors (such as weather, daily traffic and type of infrastructure element). This information may be aggregated by prediction component 562 in map layers depicting the performance of the infrastructure over larger regions and can be utilized for construction planning purposes by relevant entities, as well as routing algorithms that ingest such information.

Prediction component 562 may output a map layer construction using predictive models yielding the performance of infrastructure elements in present and future time points. In some examples, the term performance may refer to characteristics pertinent to how visible the discussed infrastructure elements are in the eyes of drivers and driver assist/autonomous systems.

In some examples, infrastructure component may include routing component 560. Routing component 560 may determine navigation routes based on infrastructure performance values. Routing component 560 may select one or more infrastructure performance values that are indicative of infrastructure performance of the pathway article. The infrastructure performance values may be included in infrastructure performance data 566. In some examples, infrastructure performance values correspond to a roadway portion. Routing component 560 may determine, based at least in part on the infrastructure performance values, a navigation route comprising a plurality of roadway portions from an initial location to a subsequent location. For example, routing component 560 may implement one or more path planning algorithms that generate a graph of edges and vertices and apply cost-values to edges that are based at least in part on current and/or predicted infrastructure performance values. Path planning algorithms may generate cost values based on aggregate, summed, weighted, or other functions. For instance, a function may include multiple variables and one or more of the variables may be weighted or unweighted. Each variable may correspond to one or more user-defined constraints or one or more infrastructure performance features that correspond to respective infrastructure performance data. Routing component 560 may select one or more navigation routes through the graph from a set of one or more possible navigation routes in the graph. The selected navigation routes may be selected based on one or more criteria or functions. For example, routing component 560 may select an optimal set of one or more navigation routes based on minimum aggregate cost, maximum aggregate cost, average cost across all roadway portions, or any other suitable selection function.

Routing component 560 may perform or cause one or more other components to perform at least one operation based at least in part on the navigation route comprising the plurality of roadway portions from the initial location to the subsequent location. For example, routing component 560 may cause service component 556 to perform one or more service. In another example, prediction component 562 may cause UI component 554 to generate one or more outputs.

In some examples, to determine a navigation route comprising a plurality of roadway portions, routing component 560 may determine one or more roadway portion sets. Each respective roadway portion set in the one or more roadway portion sets may include a respective plurality of roadway portions that form a complete path from the initial location to the subsequent location. For at least one roadway portion set, routing component 560 may determine a respective infrastructure performance value for each respective roadway portion in the at last one roadway portion set. Routing component 560 may select, based at least in part on the respective infrastructure performance values, the at least one roadway portion set as the navigation route. In some examples, for the at least one roadway portion set, routing component 560 may determine a respective distance value for each respective roadway portion in the at last one roadway portion set. Routing component 560 may select, based at least in part on the respective infrastructure performance values and the respective distance values, the at least one roadway portion set as the navigation route. In some examples, the navigation path is a first navigation path, wherein a length of the first navigation path is longer than a length of a second navigation path that is not based on one or more respective infrastructure performance values.

In some examples, to select the at least one roadway portion set as the navigation route, routing component 560 may, for the at least one roadway portion set, determine a respective traffic congestion value for each respective roadway portion in the at last one roadway portion set. A traffic congestion value may indicate a level or degree of traffic congestion at a portion of a roadway. Routing component 560 may select, based at least in part on the respective infrastructure performance values and the respective traffic congestion values, the at least one roadway portion set as the navigation route. In some examples, the navigation path is a first navigation path, wherein a congestion level of the first navigation path is greater than a congestion level of a second navigation path that is not based on one or more infrastructure performance values.

In some examples, to select the at least one roadway portion set as the navigation route, routing component 560 may determine one or more respective autonomous driving level constraints for the navigation route; and select, based at least in part on the respective infrastructure performance values and the one or more respective autonomous driving level constraints, the at least one roadway portion set as the navigation route. An autonomous driving level constraint may specify a maximum, minimum, or otherwise specified user- or machine-configured autonomous driving level.

In some examples, to select the at least one roadway portion set as the navigation route, routing component 560 may for the at least one roadway portion set, determine a roadway condition value for each respective roadway portion in the at last one roadway portion set. Routing component 560 may select, based at least in part on the respective infrastructure performance values and the roadway condition values, the at least one roadway portion set as the navigation route. A roadway condition value may indicate one or more properties or characteristics of the roadway, such as number of roadway defects (e.g., potholes, heaves, cracks, etc.), type of roadway, number of lanes on the roadway, or the like.

In some examples, to determine an aggregate value, routing component 560 may generate, as the aggregate value, a weighted composite based at least in part on the two or more of a distance value, an infrastructure performance value, a traffic congestion value, or an autonomous driving level constraint. In some examples, infrastructure performance comprises a characteristic indicating at least one of a chromaticity or luminosity of light that corresponds to the pathway article. In some examples, infrastructure performance value for a respective roadway portion of the plurality of roadway portions may comprise at least one of a retroreflectivity value of a roadway sign or a cap-Y value of a pavement marking.

In some examples, the infrastructure performance features do not include features that physically obstruct visibility of the pathway article. In some examples, the infrastructure performance features do not include physical features of the roadway that are external to the pathway article. In some examples, the physical features of the roadway that are external to the pathway article comprise one or more of potholes, heaves, cracks, or tar marks.

In some examples, routing component 560 may generate a set of tuples. Each respective tuple comprises at least a respective infrastructure performance value and respective location information for the respective infrastructure performance value. The respective location information corresponds to a respective location of a roadway associated with the respective infrastructure performance value. In some examples routing component 560 may generate, based at last in part on the set of tuples, a map that indicates the navigation route comprising a plurality of roadway portions from the initial location to the subsequent location.

Routing component 560 may use information pertinent to the performance of infrastructure elements (such as pavement markings and traffic signs) in navigation schemes as part of the route-selection/path-planning process. In particular, vehicles equipped with driver assist systems such as lane keep assist as well as autonomous functions (e.g. autopilot) can benefit from prior information that describes the conditions of the alternative paths between their origin and destination introducing bias towards routes that are capable of optimizing their advanced functionality. Routing component 560 may embed or utilize information about the performance of pavement markings and traffic signs as they are perceived by the relevant on-vehicle systems. In some examples, routing component 560 may generate the shortest path for an origin-destination pair that also factors in the engagement of a drive-assist system while optimizing the path.

Routing component 560 may generate a graph of a road network where points such as origins and destinations are vertices of a graph denoted by vᵢ, while road segments joining vertices vᵢ and vⱼ are denoted by the edge e_{i,j}. Edge weights or cost values may be assigned to the non-negative expected time to traverse the link factoring in real-time and historic traffic data as well as weather, road surface condition data, construction and incident data and are denoted by f (e_{i,j})∈ [symbol] ³⁰ . In an example path planning optimization scheme for generating or identifying navigation routes, routing component 560 may identify the collection of edges of this graph that minimizes the cost over all realizable paths that initiate at the origin and end at the destination. The solution to this minimization problem is then a collection of vertices P={v₀, v₁, vₙ}, where v₀=V_{origin} and vₙ destination such that it minimizes the Σᵢ₌₀ⁿ⁻¹f(e_{i,i+1}) over all possible paths.

In a proposed alteration to this scheme routing component 560 may introduce a function g(e_{i,j})∈ [symbol] ⁺ over the edges that describes the ability or inability of the road segment for supporting assisted and autonomous functionality of passing vehicles with respect to the quality of pathway articles, such as pavement markings and traffic signs, associated with this segment. The lower the number determined by routing component 560, the more drive-assist friendly the road segment. In this way, the optimization objective may become at a high-level, minimizing Σᵢ₌₀ⁿ⁻¹(αf(e_{i,i+1})+(1−α)g(e_{i,i+1})), where α∈[0,1] is a mixing coefficient balancing the trade-off between shorter travel time and driver assist enablement over the selected path.

In some examples, computing device 134 may include remote service component 556. Remote service component 556 may provide one or more services to remote computing devices, such as computing device 116 included in vehicle 110A. Remote service component 556 may send information stored in service data 568 that indicates one or more operations, rules, or other data that is usable by computing device 116 and/or vehicle 110A. For example, operations, rules, or other data may indicate vehicle operations, traffic or pathway conditions or characteristics, objects associated with a pathway, other vehicle or pedestrian information, or any other information usable by computing device 116 and/or vehicle 110A.

In some examples, UI component 554 may provide one or more user interfaces that enable a user to configure or otherwise operate infrastructure component 152 and service component 122.

The examples described in this disclosure may be performed in any of the environments and using any of the articles, systems, and/or computing devices described in the figures and examples described herein. Although various components and operations of FIG. 2 are illustrated as implemented in computing device 134, in other examples, the components and operations may be implemented on different and/or separate computing devices.

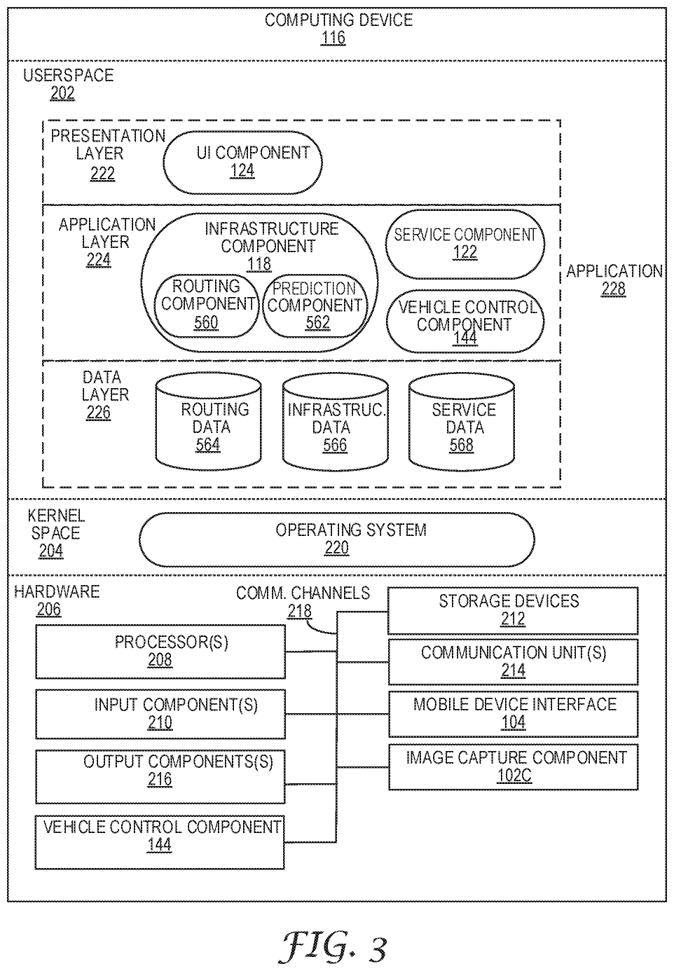

FIG. 3 is a block diagram illustrating an example computing device, in accordance with one or more aspects of the present disclosure. FIG. 3 illustrates only one example of a computing device. Many other examples of computing device 116 may be used in other instances and may include a subset of the components included in example computing device 116 or may include additional components not shown example computing device 116 in FIG. 3.

In some examples, computing device 116 may be a server, tablet computing device, smartphone, wrist- or head-worn computing device, laptop, desktop computing device, or any other computing device that may run a set, subset, or superset of functionality included in application 228. In some examples, computing device 116 may correspond to vehicle computing device 116 onboard PAAV 110, depicted in FIG. 1. In other examples, computing device 116 may also be part of a system or device that produces signs and correspond to computing device 134 depicted in FIG. 1.

As shown in the example of FIG. 3, computing device 116 may be logically divided into user space 202, kernel space 204, and hardware 206. Hardware 206 may include one or more hardware components that provide an operating environment for components executing in user space 202 and kernel space 204. User space 202 and kernel space 204 may represent different sections or segmentations of memory, where kernel space 204 provides higher privileges to processes and threads than user space 202. For instance, kernel space 204 may include operating system 220, which operates with higher privileges than components executing in user space 202. In some examples, any components, functions, operations, and/or data may be included or executed in kernel space 204 and/or implemented as hardware components in hardware 206. As shown in FIG. 3, hardware 206 includes one or more processors 208, input components 210, storage devices 212, communication units 214, output components 216, mobile device interface 104, image capture component 102C, and vehicle control component 144. Processors 208, input components 210, storage devices 212, communication units 214, output components 216, mobile device interface 104, image capture component 102C, and vehicle control component 144 may each be interconnected by one or more communication channels 218. Communication channels 218 may interconnect each of the components 102C, 104, 208, 210, 212, 214, 216, and 144 for inter-component communications (physically, communicatively, and/or operatively). In some examples, communication channels 218 may include a hardware bus, a network connection, one or more inter-process communication data structures, or any other components for communicating data between hardware and/or software.

One or more processors 208 may implement functionality and/or execute instructions within computing device 116. For example, processors 208 on computing device 116 may receive and execute instructions stored by storage devices 212 that provide the functionality of components included in kernel space 204 and user space 202. These instructions executed by processors 208 may cause computing device 116 to store and/or modify information, within storage devices 212 during program execution. Processors 208 may execute instructions of components in kernel space 204 and user space 202 to perform one or more operations in accordance with techniques of this disclosure. That is, components included in user space 202 and kernel space 204 may be operable by processors 208 to perform various functions described herein.

One or more input components 210 of computing device 116 may receive input. Examples of input are tactile, audio, kinetic, and optical input, to name only a few examples. Input components 210 of computing device 116, in one example, include a mouse, keyboard, voice responsive system, video camera, buttons, control pad, microphone or any other type of device for detecting input from a human or machine. In some examples, input component 210 may be a presence-sensitive input component, which may include a presence-sensitive screen, touch-sensitive screen, etc.

One or more communication units 214 of computing device 116 may communicate with external devices by transmitting and/or receiving data. For example, computing device 116 may use communication units 214 to transmit and/or receive radio signals on a radio network such as a cellular radio network. In some examples, communication units 214 may transmit and/or receive satellite signals on a satellite network such as a Global Positioning System (GPS) network. Examples of communication units 214 include a network interface card (e.g. such as an Ethernet card), an optical transceiver, a radio frequency transceiver, a GPS receiver, or any other type of device that can send and/or receive information. Other examples of communication units 214 may include Bluetooth®, GPS, 3G, 4G, and Wi-Fi® radios found in mobile devices as well as Universal Serial Bus (USB) controllers and the like.

In some examples, communication units 214 may receive data that includes one or more characteristics of a vehicle pathway. In examples where computing device 116 is part of a vehicle, such as PAAV 110 depicted in FIG. 1, communication units 214 may receive information about a pathway article from an image capture device, as described in relation to FIG. 1. In other examples, such as examples where computing device 116 is part of a system or device that produces signs, communication units 214 may receive data from a test vehicle, handheld device or other means that may gather data that indicates the characteristics of a vehicle pathway, as described above in FIG. 1 and in more detail below. Computing device 116 may receive updated information, upgrades to software, firmware and similar updates via communication units 214.

One or more output components 216 of computing device 116 may generate output. Examples of output are tactile, audio, and video output. Output components 216 of computing device 116, in some examples, include a presence-sensitive screen, sound card, video graphics adapter card, speaker, cathode ray tube (CRT) monitor, liquid crystal display (LCD), or any other type of device for generating output to a human or machine. Output components may include display components such as cathode ray tube (CRT) monitor, liquid crystal display (LCD), Light-Emitting Diode (LED) or any other type of device for generating tactile, audio, and/or visual output. Output components 216 may be integrated with computing device 116 in some examples.

In other examples, output components 216 may be physically external to and separate from computing device 116, but may be operably coupled to computing device 116 via wired or wireless communication. An output component may be a built-in component of computing device 116 located within and physically connected to the external packaging of computing device 116 (e.g., a screen on a mobile phone). In another example, a presence-sensitive display may be an external component of computing device 116 located outside and physically separated from the packaging of computing device 116 (e.g., a monitor, a projector, etc. that shares a wired and/or wireless data path with a tablet computer).

Hardware 206 may also include vehicle control component 144, in examples where computing device 116 is onboard a PAAV. Vehicle control component 144 may have the same or similar functions as vehicle control component 144 described in relation to FIG. 1.

One or more storage devices 212 within computing device 116 may store information for processing during operation of computing device 116. In some examples, storage device 212 is a temporary memory, meaning that a primary purpose of storage device 212 is not long-term storage. Storage devices 212 on computing device 116 may configured for short-term storage of information as volatile memory and therefore not retain stored contents if deactivated. Examples of volatile memories include random access memories (RAM), dynamic random access memories (DRAM), static random access memories (SRAM), and other forms of volatile memories known in the art.

Storage devices 212, in some examples, also include one or more computer-readable storage media. Storage devices 212 may be configured to store larger amounts of information than volatile memory. Storage devices 212 may further be configured for long-term storage of information as non-volatile memory space and retain information after activate/off cycles.

Examples of non-volatile memories include magnetic hard discs, optical discs, floppy discs, flash memories, or forms of electrically programmable memories (EPROM) or electrically erasable and programmable (EEPROM) memories. Storage devices 212 may store program instructions and/or data associated with components included in user space 202 and/or kernel space 204.

As shown in FIG. 3, application 228 executes in userspace 202 of computing device 116. Application 228 may be logically divided into presentation layer 222, application layer 224, and data layer 226. Presentation layer 222 may include user interface (UI) component 124, which generates and renders user interfaces of application 228. Application 228 may include, but is not limited to: UI component 124, infrastructure component 118, infrastructure component 118, routing component 560, prediction component 562, service component 122 and vehicle control component 228. Infrastructure component 118, routing component 560, and/or prediction component 562 may perform the same or similar operations as the like-named components of computing device 134 in FIG. 2.

Data layer 226 may include one or more datastores. A datastore may store data in structure or unstructured form. Example datastores may be any one or more of a relational database management system, online analytical processing database, table, or any other suitable structure for storing data. Example data stores may include routing data 564, infrastructure data 566, and service data 568, each of each may include data as described in FIG. 2

Service data 233 may include any data to provide and/or resulting from providing a service of service component 122. For instance, service data may include information about pathway articles (e.g., security specifications), user information, or any other information. Image data 232 may include one or more images that are received from one or more image capture devices, such as image capture devices 102 described in relation to FIG. 1. In some examples, the images are bitmaps, Joint Photographic Experts Group images (JPEGs), Portable Network Graphics images (PNGs), or any other suitable graphics file formats.

In the example of FIG. 3, one or more of communication units 214 may receive, from an image capture device, an image of a pathway article that includes an article message, such as article message 126 in FIG. 1. In some examples, UI component 124 or any one or more components of application layer 224 may receive the image of the pathway article and store the image in image data 232.

In response to receiving the image, infrastructure component 118 may determine that a pathway article is an enhanced sign, such as enhanced sign 108. The pathway article may include at least one article message that indicates one or more characteristics of a pathway for the PAAV. The article message may include primary, or human-perceptible information that indicates one or more first characteristics of the vehicle pathway. An enhanced sign may also include additional or machine-perceptible information that indicates the one or more additional characteristics of the vehicle pathway. In some examples the additional information may information include one or more of a predicted trajectory, an incline change, a change in width, a change in road surface, a defect in the pathway or other potential hazard, the location of other pathway articles, speed limit change, or any other information. An example of a predicted trajectory may include the shape of the vehicle pathway depicted by arrow 126A in FIG. 1. As described above for area 126F, in some examples the additional information includes machine readable information that is detectable outside the visible light spectrum, such as by IR, a change in polarization or similar techniques.

Infrastructure component 118 may determine one or more characteristics of a vehicle pathway and transmit data representative of the characteristics to other components of computing device 116, such as service component 122. Infrastructure component 118 may determine the characteristics of the vehicle pathway indicate an adjustment to one or more functions of the vehicle. For example, the enhanced sign may indicate that the vehicle is approaching a construction zone and there is a change to the vehicle pathway. Computing device 116 may combine this information with other information from other sensors, such as image capture devices, GPS information, information from network 114 and similar information to adjust the speed, suspension or other functions of the vehicle through vehicle control component 144.

Similarly, computing device 116 may determine one or more conditions of the vehicle. Vehicle conditions may include a weight of the vehicle, a position of a load within the vehicle, a tire pressure of one or more vehicle tires, transmission setting of the vehicle and a powertrain status of the vehicle. For example, a PAAV with a large powertrain may receive different commands when encountering an incline in the vehicle pathway than a PAAV with a less powerful powertrain (i.e. motor).

Computing device may also determine environmental conditions in a vicinity of the vehicle. Environmental conditions may include air temperature, precipitation level, precipitation type, incline of the vehicle pathway, presence of other vehicles and estimated friction level between the vehicle tires and the vehicle pathway.

Computing device 116 may combine information from vehicle conditions, environmental conditions, infrastructure component 118 and other sensors to determine adjustments to the state of one or more functions of the vehicle, such as by operation of vehicle control component 144, which may interoperate with any components and/or data of application 228. For example, infrastructure component 118 may determine the vehicle is approaching a curve with a downgrade, based on interpreting an enhanced sign on the vehicle pathway. Computing device 116 may determine one speed for dry conditions and a different speed for wet conditions. Similarly, computing device 116 onboard a heavily loaded freight truck may determine one speed while computing device 116 onboard a sports car may determine a different speed.

In some examples, computing device 116 may determine the condition of the pathway by considering a traction control history of a PAAV. For example, if the traction control system of a PAAV is very active, computing device 116 may determine the friction between the pathway and the vehicle tires is low, such as during a snow storm or sleet.

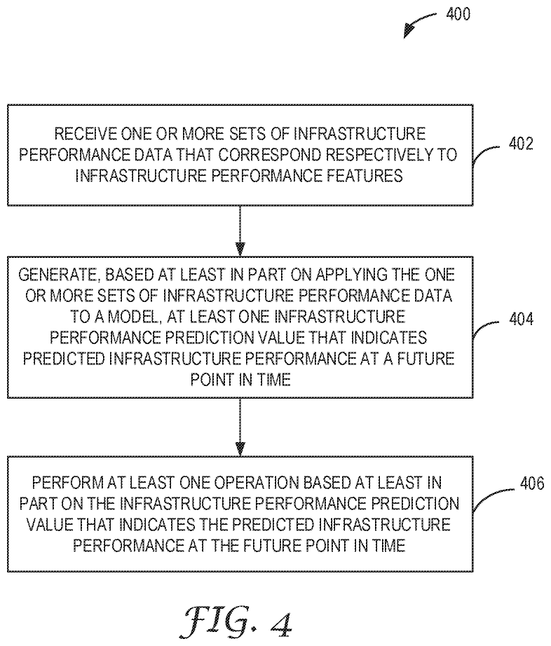

FIG. 4 is a flow diagram illustrating example operations 400 of a computing device for predicting infrastructure performance, in accordance with one or more techniques of this disclosure. The techniques are described in terms of computing device 134. However, the techniques may be performed by other computing devices. In the example of FIG. 4, computing device 134 may receive one or more sets of infrastructure performance data that correspond respectively to infrastructure performance features (402). The infrastructure performance features may influence predicted infrastructure performance of a pathway article at a future point in time. Computing device 134 may generate, based at least in part on applying the one or more sets of infrastructure performance data to a model, at least one infrastructure performance prediction value that indicates predicted infrastructure performance at the future point in time (404). The future point in time may occur after a time that the one or more sets of infrastructure performance data are applied to the model. In some examples, computing device 134 may perform at least one operation based at least in part on the infrastructure performance prediction value that indicates the predicted infrastructure performance at the future point in time.

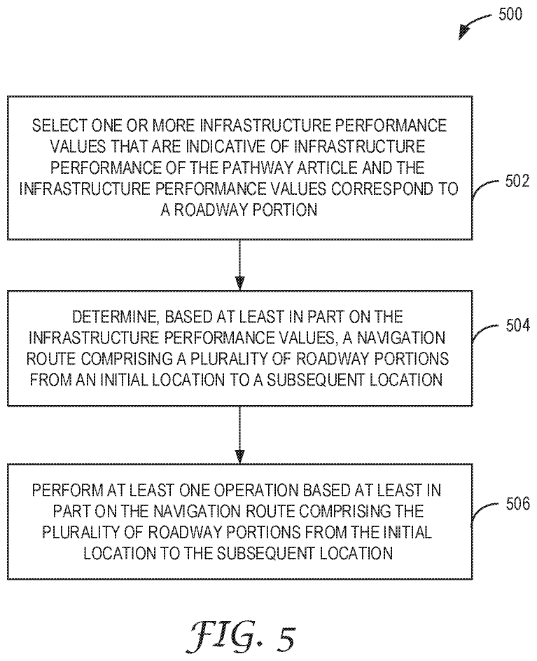

FIG. 5 is a flow diagram illustrating example operations 500 of a computing device for predicting infrastructure performance, in accordance with one or more techniques of this disclosure. The techniques are described in terms of computing device 134. However, the techniques may be performed by other computing devices. In the example of FIG. 5, computing device 134 may select one or more infrastructure performance values that are indicative of infrastructure performance of the pathway article and the infrastructure performance values correspond to a roadway portion (502). Computing device 134 may determine, based at least in part on the infrastructure performance values, a navigation route comprising a plurality of roadway portions from an initial location to a subsequent location (504). Computing device 134 may perform at least one operation based at least in part on the navigation route comprising the plurality of roadway portions from the initial location to the subsequent location (506).

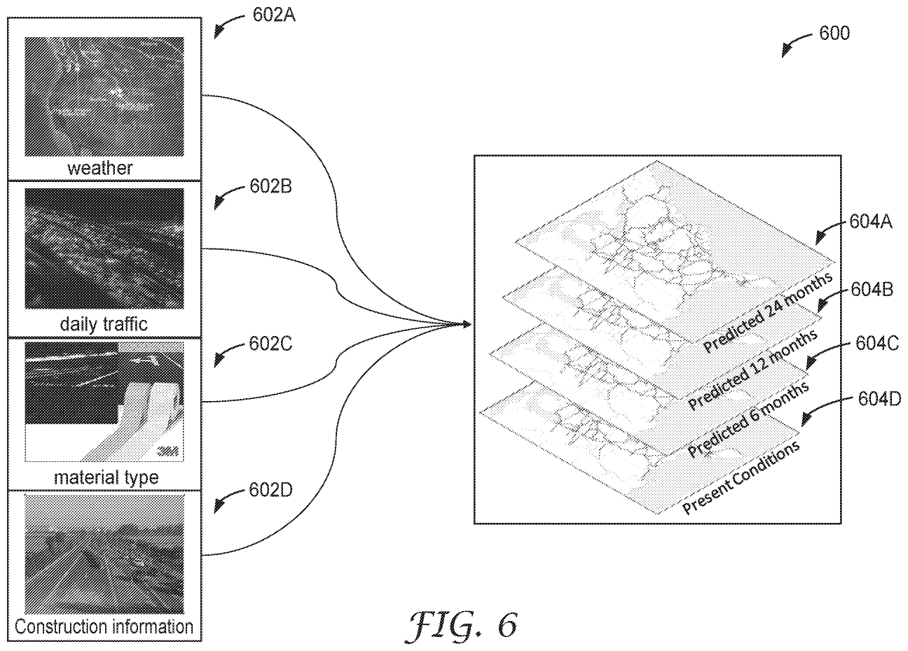

FIG. 6 is a conceptual diagram of infrastructure performance data that may be used to generate maps based on predicted infrastructure performance, in accordance with techniques of this disclosure. In the example of FIG. 6, computing device 134 may select various types of infrastructure performance data 602. Examples of infrastructure performance data include weather data 602A, traffic data 602B, pathway article material types or other properties 602C, and/or construction or work zone data 602D. Although example infrastructure performance data 602 is illustrated in FIG. 6, any other types of infrastructure performance data may also be used.

Computing device 134, implementing techniques described in this disclosure, may generate one or more maps that illustrate predicted infrastructure performance and/or current infrastructure performance. For example, FIG. 6 illustrates maps 604. Map 604A may visually indicate infrastructure performance at one or more roadway portions 24 months into the future from the time the map was generated. Map 604B may visually indicate infrastructure performance at one or more roadway portions 12 months into the future from the time the map was generated. Map 604C may visually indicate infrastructure performance at one or more roadway portions 6 months into the future from the time the map was generated. Map 604C may visually indicate infrastructure performance at one or more roadway portions 6 months into the future from the time the map was generated. Map 604C may visually indicate infrastructure performance at one or more roadway portions based on current infrastructure performance data or infrastructure performance values, or based on a current time the map is generated but using prior-determined infrastructure performance data or infrastructure performance values at earlier points in time than when the map was generated.

FIG. 7 is a conceptual diagram of infrastructure performance data that may be used with a model to predict infrastructure performance, in accordance with techniques of this disclosure. FIG. 7 illustrates infrastructure component 700. Infrastructure component 700 may include the same or similar functionality to infrastructure components 118 and 152 described in this disclosure. Infrastructure component 700 may include aggregation and temporal alignment component 702 (“ATAC 702”). ATAC 702 may aggregate infrastructure performance data 706. As shown in FIG. 7, infrastructure performance data 706 illustrates multiple different sources of infrastructure performance data that may be used by ATAC 702. ATAC 702 may determine durations that pathway articles have been installed and/or any conditions or properties associated with the pathway articles and/or pathways. Models 704 may be trained by infrastructure component 700 based on aggregated data that is structured and/or labeled based on time and/or duration of the infrastructure performance data 706. As described in this disclosure, models 704 may be trained based on the infrastructure performance data from ATAC 702, such that when later infrastructure performance data is applied to models 704, the models 704 may output predicted infrastructure performance values.

FIG. 7 further illustrates endpoint component 710, which may be included as part of infrastructure component 700 or may be a separate component. Like infrastructure component 700, endpoint component 710 may be combination of hardware and/or software and may be implemented in one or more computing devices. Endpoint component 710 may generate output based on infrastructure performance values. For example, endpoint component 710 may send endpoint component values to other computing devices. In the example of FIG. 7, endpoint component 710 may generate one or more graphical representations based on predicted infrastructure performance values. For example, endpoint component 710 may generate one or more maps 708 for display with overlays based on predicted and/or current infrastructure performance values. Any other suitable outputs may be generated by endpoint 710.

FIG. 7 presents a system level example of this disclosure. The system may include four components that perform associated functionality. The first comprises of a collection of databases (infrastructure performance data 706) that contain the relevant data that is being utilized in order to train the proposed predictive models that characterize the degradation of the materials over time. Such databases may include the following sources of data streams that characterize infrastructure element's performance: Private datasets (including information with respect to installation conditions); Public relevant datasets collected by alternate entities such as DOTs; Crowdsourced datasets collected from probes of various types; Weather data; Traffic information; Construction planning and historic data; Private and public material type information.

The second component (ATAC 702) of the proposed system may ingest the aforementioned data sources and performs data filtering, spatio-temporal alignment of the various data sources and data aggregation. The third component (models 704) is responsible for receiving the aggregated datasets and learning models that factor in exogenous factors and material types learn models capable of predicting the material degradation over time. Endpoint component 710 of the example system may receive queries by a user (e.g., based on region) and packaging the consolidated information from the predictive models along with information with respect to planned installations and yields map layers containing the performance of the infrastructure elements over a finite horizon starting at selected date and propagating the degradation models over the predefined horizon.

Techniques of this disclosure may address problems of aggregating and learning predictive models capable of characterizing and predicting performance of roadway infrastructure elements that can serve as safety surrogates. Capitalizing on this information, roadway custodians, can better plan their construction cycles taking into account attributes such as the visibility of pavement markings in an effort to better accommodate for vehicles with lane keep assist systems as well as vehicles with more advanced autonomous capabilities. Given that pavement markings have been identified in the transition to more assisted/autonomous driving functionality, having a mechanism that characterizes their performance in present and future time points can be an enabler for safer roadways.

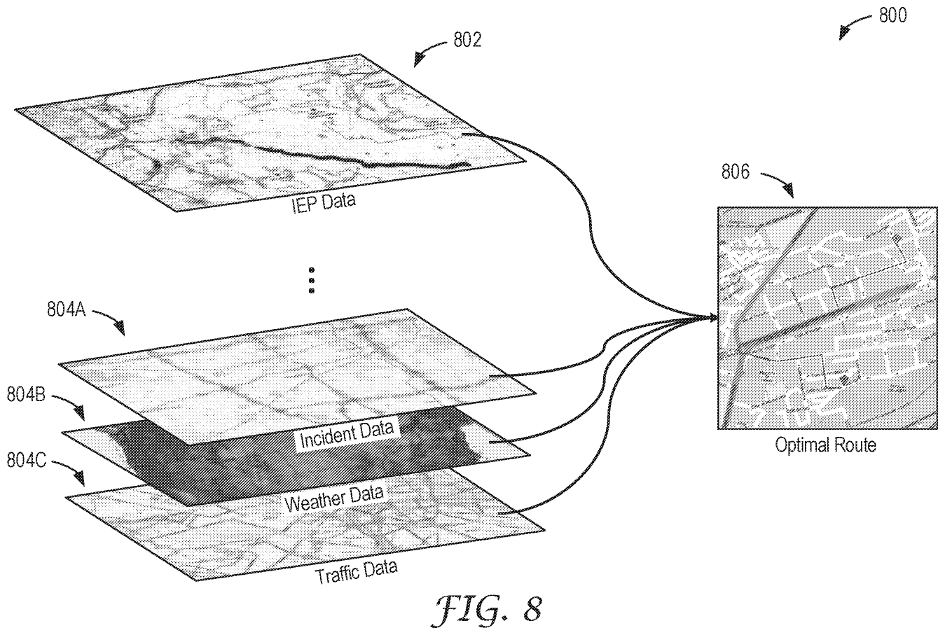

FIG. 8 illustrates maps that may be generated by a computing device for infrastructure performance, in accordance with techniques of this disclosure. A graphical user interface may be generated by a computing device and include one or more of maps 802, 804A-804C, and/or 806. As shown in FIG. 8, map 802 may be generated with infrastructure performance values or (“IEP Data”) shown in 802 as an overlay of colored points along a navigation path or roadway. Other maps, such as 804A-804C (relating to incident data, weather data, and/or traffic data), may be generated by components such as infrastructure components 118 or 152, or any other component or computing device. Infrastructure components 118 and/or 152 may combine or otherwise use infrastructure performance data and/or infrastructure performance values (whether predicted and/or current) to determine one or more navigation routes as described in this disclosure. In some examples, infrastructure components 118 and/or 152 may generate navigation routes and/or output maps with such navigation routes as described in this disclosure based on infrastructure performance data and/or infrastructure performance values (whether predicted and/or current).

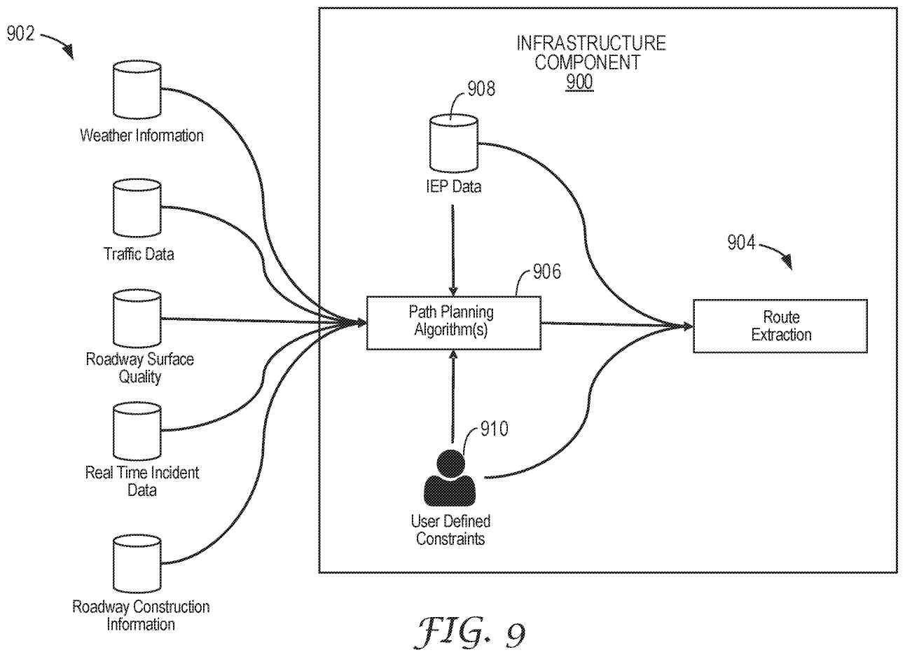

FIG. 9 is a conceptual diagram of infrastructure performance data that may be used with a model to generate navigation routes, in accordance with techniques of this disclosure. FIG. 9 illustrates infrastructure component 900. Infrastructure component 900 may include the same or similar functionality to infrastructure components 118 and 152 described in this disclosure. In the example of FIG. 9, infrastructure component 900 may select infrastructure performance data 902, 908. Infrastructure component 900 may implement one or more path planning algorithms 906. Path planning algorithms 906 may use infrastructure performance data to generate one or more navigation routes as described in this disclosure. For example, path planning algorithms 906 may generate a graph of edges and vertices and apply cost-values to edges that are based at least in part on current and/or predicted infrastructure performance values. In some examples, a user may provide, as user input, one or more user-defined criteria 910. User-defined criteria 910 may refer to minimum or maximum autonomous driving level criteria for a navigation path, driving risk criteria (e.g., based on number of accidents or near-misses), continuous driving constraints (e.g., based on estimated or predicted number of accelerations and decelerations, which may be based on stops, speed limits, etc), or any other user-specified criteria. Path planning algorithms 906 may generate cost values based on aggregate, summed, weighted, or other functions using user-defined constraints 910 and/or infrastructure performance data 902 and/or 908. For instance, a function may include multiple variables and one or more of the variables may be weighted or unweighted. Each variable may correspond to one or more user-defined constraints or one or more infrastructure performance features that correspond to respective infrastructure performance data. Infrastructure performance component 900 may include a route extraction component 904. Route extraction component 904 may select one or more routes from a set of routes. The selected routes may be selected based on one or more criteria or functions. For example, route extraction component 904 may select an optimal set of one or more navigation routes based on minimum aggregate cost, maximum aggregate cost, average cost across all roadway portions, or any other suitable selection function.

FIGS. 10-16 illustrate graphical user interfaces that may be generated by one or more computing devices (e.g., computing devices 116 and/or 134) in accordance with techniques of this disclosure. Although FIGS. 10-16 may use pavement markings as an example of pathway articles, any other one or more pathway articles may also be used in accordance with techniques of this disclosure to generate user interfaces. Any of the overlays or points of any of FIGS. 10-16 may be used together or otherwise combined to generate multi-overlay or aggregate overlays that represent multiple individual overlays and/or new overlays that aggregate multiple overlays into a single overlay.

FIG. 10 illustrates graphical user interfaces generated by a computing device for infrastructure performance, in accordance with techniques of this disclosure. Graphical user interfaces 1000A-1000D may be generated by a computing device. Each of graphical user interfaces 1000A-1000D may include a respective infrastructure performance overlay 1002A-1002D. Each overlay may include a set of points or differing values that are associated with current or predicted infrastructure performance values. Performance values may be represented on a color spectrum. A higher retroreflective value may be represented with a dark green color while dark red depicts pavement markings of low retroreflective performance. Any other techniques for visual differentiation may be used such as size, pattern, arrangement, shape, or the like.

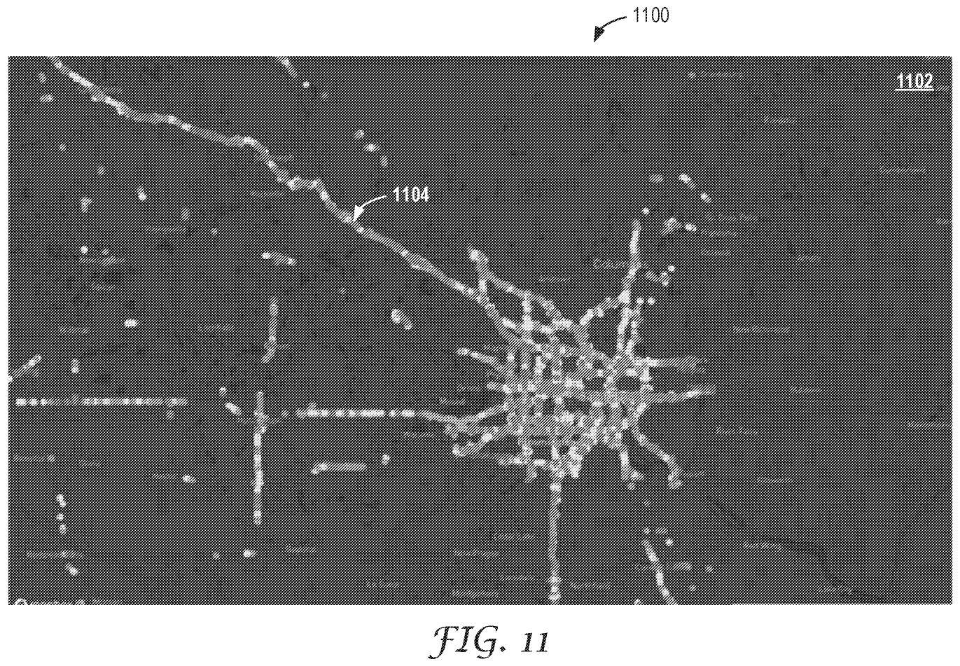

FIG. 11 illustrates a graphical user interface generated by a computing device for infrastructure performance, in accordance with techniques of this disclosure. Graphical user interface 1100 may be generated by a computing device and include map 1102. Map 1102 may be a regional map with a vehicle incident data overlay 1104. The incident overlay map 1102 may include an incident classification ranging from minor to severe (which may be based on a range of discrete or non-discrete values) that occurred over a configured period of time. Each vehicle incident data point of overlay 1104 may color coded where red data points are vehicle involved crashes, yellow data points are vehicle stalls, and green data points are temporary road work sites. Any other techniques for visual differentiation may be used such as size, pattern, arrangement, shape, or the like.

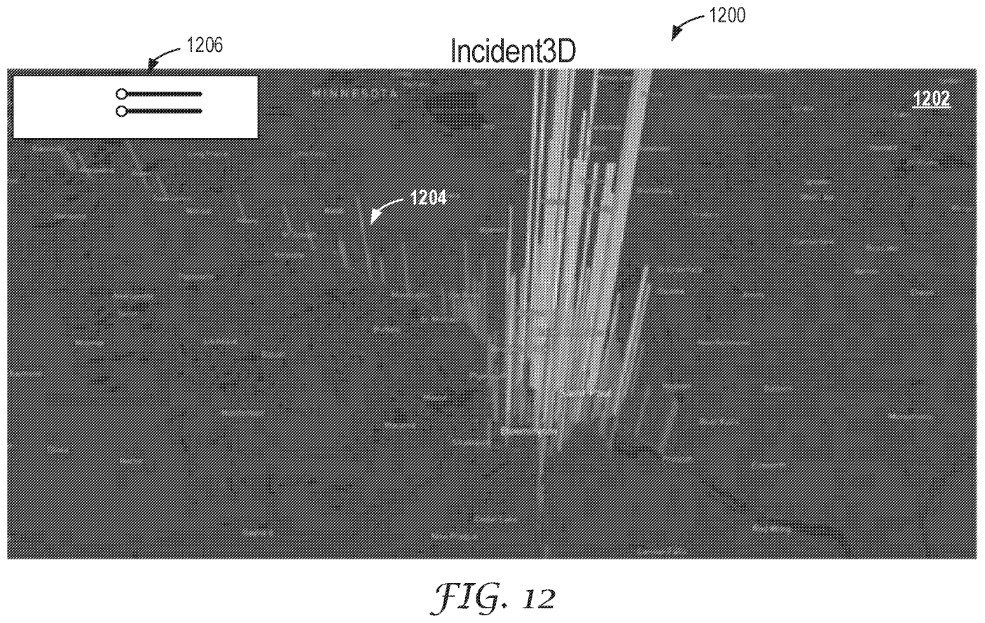

FIG. 12 illustrates a graphical user interface generated by a computing device for infrastructure performance, in accordance with techniques of this disclosure. Graphical user interface 1200 may be generated by a computing device and include map 1202. Map 1202 may be a regional map with an incident data histogram overlay 1204 where the overlay. The overlay 1204 may be filtered by incidents occurring in the month of January between midnight and 1:00 am, although any filters may be used for date, time, location, or any other filterable characteristic. Filters may be controllable by a human or machine using graphical component 1206. The histogram may provide a count of incidents within a given location along a roadway.

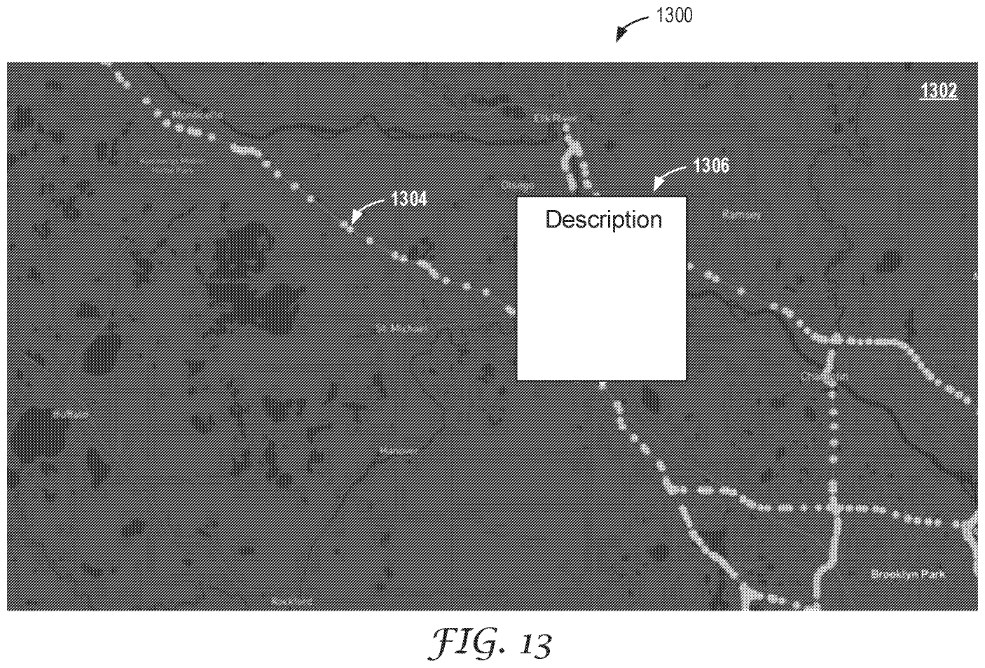

FIG. 13 illustrates a graphical user interface generated by a computing device for infrastructure performance, in accordance with techniques of this disclosure. Graphical user interface 1300 may be generated by a computing device and include map 1302. A regional map with a traffic flow monitor data overlay 1304. Each dot or point of overlay 1304 represents a traffic flow monitor which may include inductive loops. A data point may include, but is not limited to: location, name, speed limits, the detector name, such as displayed in graphical component 1306. The station may get pinged speed and flow estimates. May overlay may include or represent traffic density.

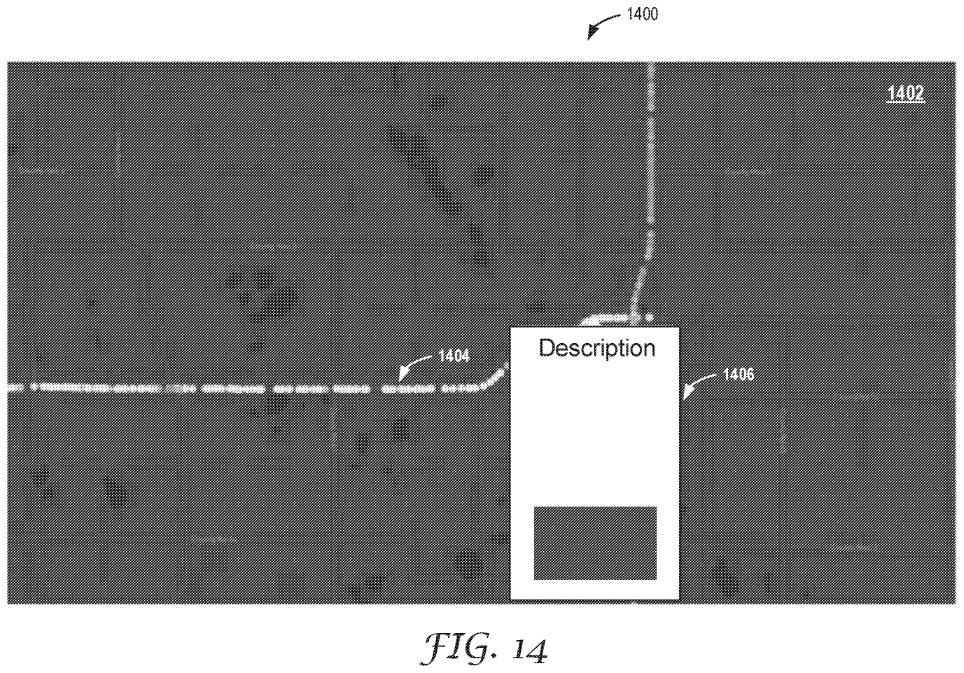

FIG. 14 illustrates a graphical user interface generated by a computing device for infrastructure performance, in accordance with techniques of this disclosure. Graphical user interface 1400 may be generated by a computing device and include map 1402. Map 1402 may be a local map with pavement marking data overlay 1404. Each pavement marking data point in overlay 1404 may represent infrastructure performance values and/or infrastructure performance data generated or collected for pavement marking deployed on the roadway. A pavement marking data point may include, but is not limited to: the entity that measured the pavement marking, the direction of vehicle travel on the roadway, the road way name, the date the measurement was collected, the type of pavement marking, at least one pavement marking performance characteristic, and a picture of the pavement marking deployed in the environment. Performance characteristics may include: pavement marking contrast and retroreflectivity. Example pavement marking data is illustrated in graphical component 1406, including measurement unit, direction, highway, measurement year, user type, performance.

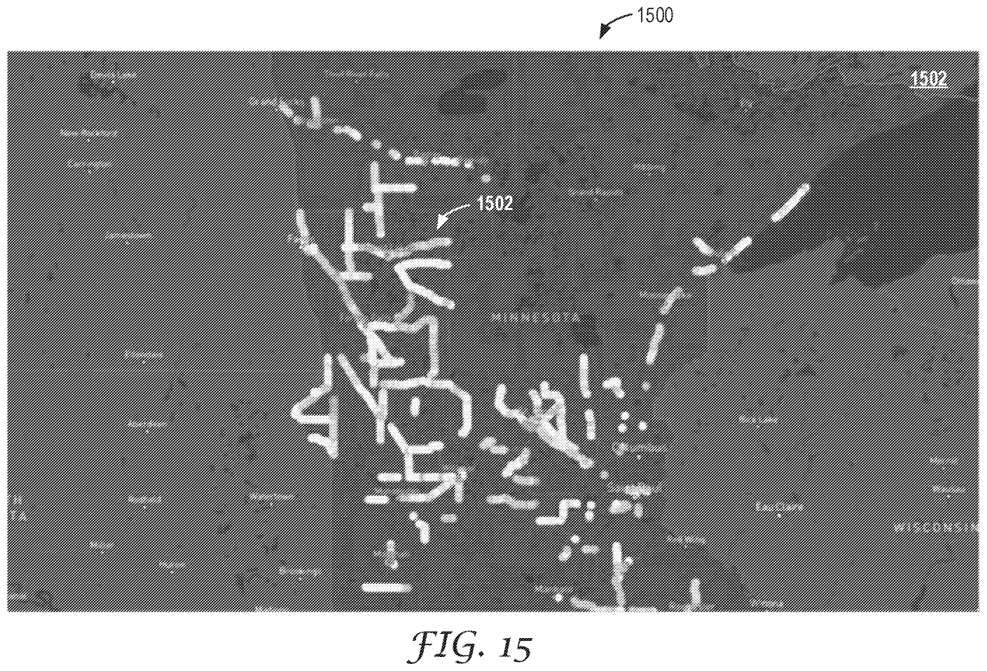

FIG. 15 illustrates a graphical user interface generated by a computing device for current infrastructure performance, in accordance with techniques of this disclosure. Graphical user interface 1500 may be generated by a computing device and include map 1502. Map 1502 may be a regional map with a pavement marking performance overlay 1504 where the overlay is the current state of the retroreflective performance of the pavement markings based on when the measurements were collected. Pavement marking performance overlay 1504 in FIG. 15 may be set by a user or machine to a current performance state and may or may not include a retroreflective performance threshold. In another example, techniques of this disclosure may include a predicted infrastructure performance where infrastructure performance values for pavement markings collected at different points in time. Predicted infrastructure performance may be generated by a computing device for each data point in pavement marking performance overlay 1504 to provide a predicted infrastructure performance.

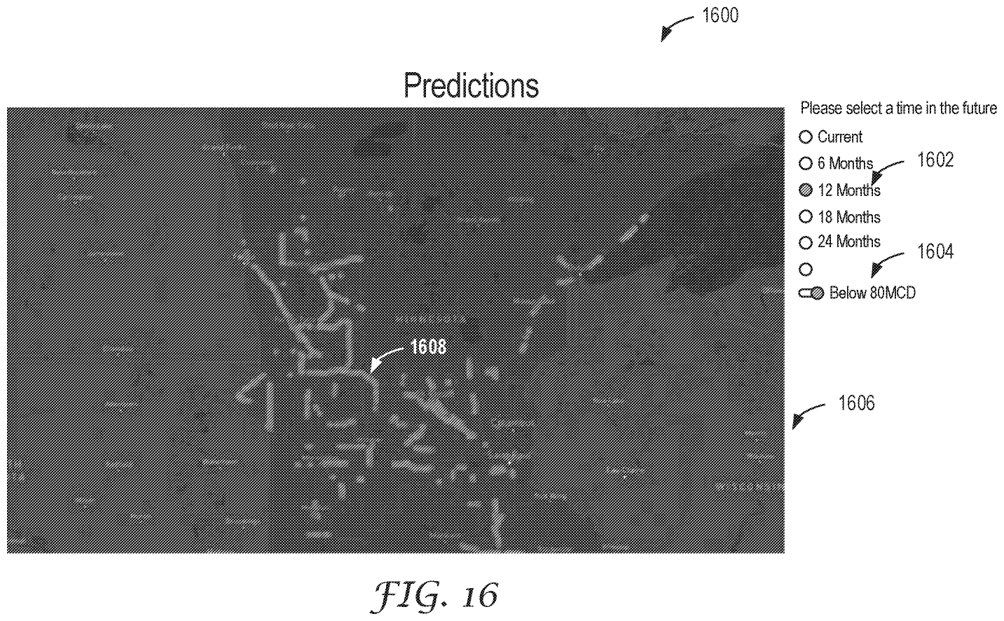

FIG. 16 illustrates a graphical user interface generated by a computing device for predicted infrastructure performance, in accordance with techniques of this disclosure. Graphical user interface 1600 may include map 1606. Map 1606 may be a regional map with pavement marking overlay 1608 filtered to show pavement marking data points where the pavement markings are predicted to below a set retroreflective performance threshold in 12 months from the current date. The performance threshold or setting may be configured via user or machine input with graphical control 1602. The set retroreflective threshold in the figure is 80 mcd, although any suitable value may be used. The retroreflective threshold or setting may be configured via user or machine input with graphical control 1604. A user, such as a road authority, may use map 1606 to aid in infrastructure repair planning or to aid in an infrastructure quality report. The predictions in FIG. 16 may use a linear degradation model for purpose of demonstration, although non-linear degradation models may also be used.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor”, as used may refer to any of the foregoing structure or any other structure suitable for implementation of the techniques described. In addition, in some aspects, the functionality described may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set).

Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

It is to be recognized that depending on the example, certain acts or events of any of the methods described herein can be performed in a different sequence, may be added, merged, or left out altogether (e.g., not all described acts or events are necessary for the practice of the method). Moreover, in certain examples, acts or events may be performed concurrently, e.g., through multi-threaded processing, interrupt processing, or multiple processors, rather than sequentially.

In some examples, a computer-readable storage medium includes a non-transitory medium. The term “non-transitory” indicates, in some examples, that the storage medium is not embodied in a carrier wave or a propagated signal. In certain examples, a non-transitory storage medium stores data that can, over time, change (e.g., in RAM or cache).

Various examples of the disclosure have been described. These and other examples are within the scope of the following claims.

1. A computing device comprising:
one or more computer processors, and
a memory comprising instructions that when executed by the one or more computer processors cause the one or more computer processors to:
select one or more infrastructure performance values that are indicative of infrastructure performance of the pathway article and the infrastructure performance values correspond to a roadway portion;
determine, based at least in part on the infrastructure performance values, a navigation route comprising a plurality of roadway portions from an initial location to a subsequent location; and
perform at least one operation based at least in part on the navigation route comprising the plurality of roadway portions from the initial location to the subsequent location.

2. The computing device of claim 1, wherein to determine the navigation route comprising a plurality of roadway portions, the memory comprising instructions that when executed by the one or more computer processors cause the one or more computer processors to:
determine one or more roadway portion sets, wherein each respective roadway portion set in the one or more roadway portion sets comprises a respective plurality of roadway portions that form a complete path from the initial location to the subsequent location;
for at least one roadway portion set, determine a respective infrastructure performance value for each respective roadway portion in the at last one roadway portion set;
select, based at least in part on the respective infrastructure performance values, the at least one roadway portion set as the navigation route.

3. The computing device of claim 2, wherein to select the at least one roadway portion set as the navigation route, the memory comprising instructions that when executed by the one or more computer processors cause the one or more computer processors to:
for the at least one roadway portion set, determine a respective distance value for each respective roadway portion in the at last one roadway portion set;
select, based at least in part on the respective infrastructure performance values and the respective distance values, the at least one roadway portion set as the navigation route.

4. The computing device of claim 3, wherein the navigation path is a first navigation path, wherein a length of the first navigation path is longer than a length of a second navigation path that is not based on one or more respective infrastructure performance values.

5. The computing device of claim 2, wherein to select the at least one roadway portion set as the navigation route, the memory comprising instructions that when executed by the one or more computer processors cause the one or more computer processors to:
for the at least one roadway portion set, determine a respective traffic congestion value for each respective roadway portion in the at last one roadway portion set;
select, based at least in part on the respective infrastructure performance values and the respective traffic congestion values, the at least one roadway portion set as the navigation route.

6. The computing device of claim 5, wherein the navigation path is a first navigation path, wherein a congestion level of the first navigation path is greater than a congestion level of a second navigation path that is not based on one or more infrastructure performance values.

7. The computing device of claim 2, wherein to select the at least one roadway portion set as the navigation route, the memory comprising instructions that when executed by the one or more computer processors cause the one or more computer processors to:
determine one or more respective autonomous driving level constraints for the navigation route; and
select, based at least in part on the respective infrastructure performance values and the one or more respective autonomous driving level constraints, the at least one roadway portion set as the navigation route.

8. The computing device of claim 2, wherein to select the at least one roadway portion set as the navigation route, the memory comprising instructions that when executed by the one or more computer processors cause the one or more computer processors to:
for the at least one roadway portion set, determine a roadway condition value for each respective roadway portion in the at last one roadway portion set;
select, based at least in part on the respective infrastructure performance values and the roadway condition values, the at least one roadway portion set as the navigation route.

9. The computing device of claim 2, wherein to select the at least one roadway portion set as the navigation route, the memory comprising instructions that when executed by the one or more computer processors cause the one or more computer processors to:
for the at least one roadway portion set, determine an aggregate value for each respective roadway portion in the at last one roadway portion set based on two or more of a distance value, an infrastructure performance value, a traffic congestion value, or an autonomous driving level constraint;
select, based at least in part on the aggregate values, the at least one roadway portion set as the navigation route.

10. The computing device of claim 9, wherein to determine an aggregate value, the memory comprising instructions that when executed by the one or more computer processors cause the one or more computer processors to generate, as the aggregate value, a weighted composite based at least in part on the two or more of a distance value, an infrastructure performance value, a traffic congestion value, or an autonomous driving level constraint.

11. The computing device of claim 1, wherein infrastructure performance comprises a characteristic indicating at least one of a chromaticity or luminosity of light that corresponds to the pathway article.

12. The computing device of claim 11, wherein an infrastructure performance value for a respective roadway portion of the plurality of roadway portions comprises at least one of a retroreflectivity value or a cap-Y or a contrast value.

13. The computing device of claim 1, wherein the infrastructure performance features do not include features that physically obstruct visibility of the pathway article.

14. The computing device of claim 1, wherein the infrastructure performance features do not include physical features of the roadway that are external to the pathway article.

15. The computing device of claim 14, wherein the physical features of the roadway that are external to the pathway article comprise one or more of potholes, heaves, cracks, or tar marks.

16. The computing device of claim 1, wherein the memory comprises instructions that when executed by the one or more computer processors cause the one or more computer processors to:
generate a set of tuples, wherein each respective tuple comprises at least a respective infrastructure performance value and respective location information for the respective infrastructure performance value, wherein the respective location information corresponds to a respective location of a roadway associated with the respective infrastructure performance value.

17. The computing device of claim 1, wherein the memory comprises instructions that when executed by the one or more computer processors cause the one or more computer processors to:
generate, based at last in part on the set of tuples, a map that indicates the navigation route comprising a plurality of roadway portions from the initial location to the subsequent location.

18-20. (canceled)
